(19) United States
(12) Patent Application Publication
(10) Pub. No.: US 2004/0051336 A1
(43) Pub. Date: Mar. 18, 2004

(54) Conformal weather shield and garments

(76) Inventors: Dah-Shiarn Chiao, Albertson, NY (US); Chien-An Chang, Taoyuan (TW)

Correspondence Address: DahShiam Chiao, MultiSen Technology, Inc., 11 Wood Avenue, Albertson, NY, 11507, US

(21) Appl. No.: 10/246,062

(22) Filed: Sep. 17, 2002

(51) Int. Cl. B62J 23/00

(52) U.S. Cl. 296/78.1

(57) ABSTRACT

The present invention concerns a conformal weather shield and garments for use with small wheeled vehicles, for example, scooters and motorcycles, in which the driver and passenger ride atop the vehicle exposed to the weather. The weather shield comprises a primary panel made of lightweight, flexible and water-resistant material that fits in a conformal manner around the both the lower extremities of the driver and passenger, and the structure of the small wheeled vehicle. The primary panel has two openings through which the upper extremities of the driver and passenger extend. The weather garments are rainwear-like garments intended for use in combination with the conformal weather shield, and have a zipper or VELCRO-like fastener for fastening the lower portion of the weather garment to the conformal weather shield. The zipper or VELCRO-like fastener and an associated fabric gasket provide a tight fit between the weather garment and conformal weather shield. The conformal weather shield further comprises a removable protective panel for covering the two openings for accommodating the bodies of the driver and passenger when the driver and passenger have left the vehicle wearing the weather garments.

### FIELD OF THE INVENTION

The present invention concerns protective coverings for use with scooters, motorcycles and other small wheeled vehicles in which a driver and a passenger ride atop the vehicle exposed to the weather, and more particularly to protective coverings that provide a shield from the weather for the driver, passenger and vehicle.

### BACKGROUND OF THE INVENTION

The present invention concerns protective weather shields for use with small wheeled vehicles that are “ridden” in a manner that exposes a driver of the vehicle and possibly a passenger to the elements and in particular rain. Heretofore protective weather shields intended for use with small wheeled vehicles have exhibited a number of limitations that have detracted from their desirability and usefulness.

In particular, protective weather shields have been bulky, cumbersome and generally poorly fitting. Since the primary purpose of these protective weather shields is to protect the driver and passenger when caught in inclement weather so that they may continue their journey without interruption, it is important that protective weather shields minimally hinder the operation of the vehicle by the driver. The bulky, cumbersome and generally poor fit of conventional protective weather shields has hindered the normal operation of such vehicles by drivers. In contrast to high-performance foul-weather gear purposely designed to minimally restrict movement of the wearer when outside during periods of inclement weather, conventional weather shields are poncho-like and cumbersome and make effective vehicle control difficult.

Another limitation of conventional protective weather shields are their integral, one-piece construction. Although conventional protective weather shields provide some degree of protection from the elements when the driver is operating the vehicle, if the driver wishes to leave the vicinity of the vehicle, he or she will again be exposed to the elements unless he or she has brought a weather garment. This might not always be the case, since conventional weather shields are typically carried stowed in or on the vehicle and are thus usually available, while protective weather garments may not be carried when inclement weather is not expected. Thus the driver and passenger may make a makeshift protective garment out of conventional protective weather shields to protect them when they leave the vicinity of the vehicle, but this then exposes the vehicle to the weather. Or they may do without protective covering altogether and make a “dash for it” through the rain to shelter, thereby partially defeating the purpose of the protective weather shield in the first place, i.e., to stay dry.

A further limitation of conventional weather shields concerns the need to remove them nearly in their entirety to mount or exit the vehicle. This limitation also significantly detracts from the usefulness and desirability of such conventional weather shields. First, it is a difficult and time-consuming operation to detach and then re-attach conventional weather shields every time the vehicle is mounted or exited. Second, many of these operations require that the weather shield be removed for a period of time from the seating area, thereby exposing the seating area to moisture during rainy periods. The driver would then have to wipe the seating area free of moisture before he mounts the vehicle again.

Thus, drivers and passengers of small wheeled vehicles desire protective weather shields that provide a snug yet comfortable and minimally-restrictive fit that enables them to continue their journey on the wheeled vehicle without interruption. In addition, drivers particularly desire a weather shield that either provides the features of high-performance foul weather gear, or is designed to operate in combination with such gear. Further, drivers and passengers desire an easy-access system for mounting and exiting the vehicle which eliminates the need for removal and reattachment of the weather shield every time the vehicle is mounted or exited, and the attendant risk of exposing the seating area to rain.

### SUMMARY OF THE INVENTION

The limitations of the prior art are overcome in embodiments of the present invention in which a first preferred embodiment of the present invention comprises a conformal weather shield. The conformal weather shield of the first preferred embodiment comprises a top panel portion and two side panel portions. When in use, the top panel portion of the conformal weather shield is placed generally over the seating area of a scooter, motorcycle or other wheeled vehicle. The top panel portion covers the lower torso and thighs of the driver and the general seating area of the scooter or motorcycle, and the side panel portions drape downward over the legs of the driver. The conformal weather shield is made from flexible, waterproof and breathable material. The conformal weather shield of the present invention is also tailored to fit over the driver-scooter combination, thereby “conforming” relatively closely to the shape of the scooter/driver combination. In addition, the conformal weather shield generally has a sleek, aerodynamic shape that provides a smooth shape to the air stream when the scooter or motorcycle is operated. Further, the side panel portions of the conformal weather shield have leg bulges that are smoothly faired into the overall shape of the conformal weather shield. The leg bulges permit the driver to move his legs side-to-side and up-and-down while maintaining the overall smooth aerodynamic cross section of the conformal weather shield.

The top panel portion of the conformal weather shield further comprises a front portion; a middle portion; and an end portion. Attached to the front portion of the top panel portion of the conformal weather shield is a front upper attachment structure for attaching the front upper portion of the conformal weather shield to the steering column of the scooter or motorcycle in the vicinity of the handlebars and instrument cluster. In a preferred embodiment of the present invention, the front upper attachment structure comprises a drawstring passing through a tubular opening stitched in the periphery of a front edge of the top panel portion. When attaching the conformal weather shield to the scooter or motorcycle, the driver places the front upper portion of the top panel portion adjacent to the steering column in the vicinity of the handlebars and instrument cluster. The driver then passes both tag ends of the drawstring around opposite sides of the steering column, and ties them together, thereby cinching the front portion of the top panel portion to the steering column. The flexible material of the conformal weather shield forms a substantially weatherproof seal around the steering column that prevents water from passing underneath the conformal weather shield both when the scooter or motorcycle are stationary or when they are in operation.

In a first alternate embodiment of the first preferred embodiment, the front upper attachment structure comprises a loop of fabric with an opening of sufficient size to permit the opening to be passed over and around the handlebars and instrument cluster during the initial stages of a mounting operation. In order to form a tight seal around the steering column, elastic thread is stitched into the fabric loop. The elastic thread stretches enough to permit the mounting operation, but rebounds to form a tight seal around the steering column when released.

In further alternate embodiments of the present invention a flap having interlocking, VELCRO-like fabric patches or mechanical snaps may be used to cinch the front upper portion of the top panel portion around the steering column of the scooter or motorcycle. The VELCRO-like interlocking fabric patches are constructed using alternate, cooperating patches, one comprised of hook-like structures and the other comprised of loop-type structures. When brought into contact, such VELCRO-like patches adhere to one another and can be used to close seams in fabric-like materials. As used herein, “interlocking fabric patches” or “interlocking, VELCRO-like fabric patches” refer generically to any VELCRO-like fabric closing system for use in closing seams of garments and other structures constructed of fabric-like materials.

In the first preferred embodiment of the present invention, the middle portion of the top panel portion of the conformal weather shield has a substantially circular opening to accommodate the body of the driver. In the first preferred embodiment, elastic material is sewn about the periphery of the substantially circular opening. This elastic material stretches enough to permit a snug, substantially weather-tight fit about the torso of the driver. In an alternate embodiment, other tightening means may be used, for example, a draw string or flaps having interlocking, VELCRO-like fabric patches. In a still further alternate embodiment, a second substantially circular opening is provided for a passenger.

In yet another alternate embodiment, a substantially cylindrical flexible fabric gasket extends upwardly from the substantially circular opening. In this particular alternate embodiment, the driver and/or passenger may pull down a foul weather garment over the upwardly-extending substantially cylindrical fabric gasket to provide a tight seal against the weather.

In the first preferred embodiment of the present invention, the rear portion of the top panel portion further comprises a rear attachment structure for attaching the rearmost portion of the conformal weather shield to the scooter or motorcycle in the vicinity of the rearmost portion of the seating area of the scooter or motorcycle. In the first preferred embodiment, the rear attachment structure further comprises an elastic fabric portion that can be stretched over the rearmost portion of the seat structure. In alternate embodiments of the first preferred embodiment, the rear attachment structure comprises a drawstring or cooperating flaps having interlocking, VELCRO-like fabric patches.

In yet another alternate embodiment of the present invention, the rear attachment structure performs the dual functions of attaching the conformal weather shield to the scooter or motorcycle and also of storing the conformal weather shield when not in use. In this particular embodiment, the rear attachment structure comprises a screw attachment plate and fabric boot. The fabric boot comprises two oppositely-facing fabric portions having their bottom lateral ends attached to the scooter by screw attachment plates and their upper edges forming an opening. Running along the upper edges are the respective elements of snap enclosures. When the conformal weather shield is not in use, the conformal weather shield is rolled up and placed within the boot which is then snapped closed. In yet further alternate embodiments, the fabric boot may be enclosed by a zipper, or flaps having interlocking fabric patches.

In a still further alternate embodiment of the present invention, the rear attachment structure further comprises a dual purpose turn-crank storage system. The turn-crank storage system comprises a crank-operated rod and attachment assembly mounted to the rear portion of the scooter or motorcycle in the vicinity of the rear portion of the seating area. The rear portion of the top panel portion is fixedly attached to the rod. When the driver or passenger desires to store the conformal weather shield he or she simply turns the crank and rolls up the conformal weather shield for storage.

In still further alternate embodiments of the first preferred embodiment, the conformal weather shield storage boot or the crank-operated conformal weather shield storage system are mounted in a storage compartment located under the seat of the scooter or motorcycle.

In the first preferred embodiment of the present invention, the two downwardly-extending side panel portions each have a top edge; a front edge; a bottom edge; and a rear edge. The laterally extending top edges of the side panel portions are attached to, or are integrally formed with, the top panel portion. In the first preferred embodiment of the present invention, the front edge of each side panel portion has a front fairing attachment structure for attaching the front edge of each side panel portion to the front fairing structure of the scooter or motorcycle in order to form a substantially weatherproof seal between the conformal weather shield and the front fairing structure. In the first preferred embodiment, the front attachment structure comprises an elastic fabric border running along the front edge of each side panel portion. The elastic fabric border may be formed by elastic stitching or a separate piece of elastic material. The front fairing attachment structure of the first preferred embodiment is intended to operate in conjunction with cleat-like structures mounted on each side of the front fairing structure of the scooter or motorcycle. When the conformal weather shield is stretched taught and the elastic fabric border running about the periphery of the front edges of the side panel portions are stretched over the cleat-like structures and released, the front edges of the side panel portions are held in place, forming a substantially weatherproof seal.

In alternate embodiments of the first preferred embodiment, the front fairing attachment structure may comprise drawstrings running through holes in the respective front edges of the side panel portions and whose tag ends are tied together to form a substantially weatherproof seal between the conformal weather shield and the front fairing structure of the scooter or motorcycle. In a still further alternate embodiment of the first preferred embodiment, cooperating strips having interlocking, VELCRO-like fabric patches run along the front edge of each side panel portion, wherein each strip is intended to operate in conjunction with another strip of interlocking, VELCRO-like material fixedly attached to each side of the front fairing structure of the scooter or motorcycle.

In yet another alternate embodiment of the first preferred embodiment, the front fairing attachment structure may serve a dual purpose of attaching the conformal weather shield to the scooter or motorcycle and of storing the conformal weather shield. In this particular embodiment an attachment plate is mounted to each side of the front fairing structure of the scooter or motorcycle. The front edges of the side panel portions of the conformal weather shield are fixedly mounted to the scooter by screw plates. Also mounted to the attachment plates are a pair of oppositely facing fabric panels whose bottom ends are attached to the attachment plates and whose top ends form an opening. Running along the top edge of the fabric panels are the respective elements of snap enclosures. Together the fabric panels and snap enclosures form a boot for storing the conformal weather shield when not in use.

The side panel portions of the conformal weather shield of the first preferred embodiment further comprise bottom edges. Formed in each bottom edge of each side panel portion are bottom attachment structures for connecting the bottom edge of each side panel portion together. In the first preferred embodiment, the bottom attachment structures comprise at least one hole in the bottom edge of each side panel portion. A drawstring or chain and lock may be passed through the holes in the respective bottom edges of each side panel portion, in order to join the bottom edges of the side panel portions together.

In alternate embodiments of the first preferred embodiment, the bottom attachment structures may comprise flaps having interlocking fabric patches.

The first preferred embodiment of the present invention further comprises a driver/passenger opening cover panel for covering the driver and/or passenger opening in the top panel portion of the conformal weather shield when not occupied by the driver or passenger. The driver opening cover panel in combination with the conformal weather shield protects the seating area of the bike from the weather when the scooter or motorcycle is not being used. The driver opening cover panel may be attached to the top panel portion of the conformal weather shield using zippers, snaps or flaps having interlocking, VELCRO-like fabric patches.

In another alternate embodiment of the first preferred embodiment of the present invention, water-conducting channels are formed in the top panel portion and side panel portions of the conformal weather shield to better conduct water away from the body of the driver and passenger and back into the slipstream of the scooter or motorcycle when in operation, or to the ground when the scooter or motorcycle is motionless.

A second preferred embodiment of the present invention comprises a conformal weather shield having a different configuration than the conformal weather shield of the first preferred embodiment. The conformal weather shield of the second preferred embodiment otherwise comprises a top panel portion and two side panel portions similar to the conformal weather shield of the first preferred embodiment, but in contrast to the first preferred embodiment, the front of the top panel portion wraps vertically downward and the front edges of the side panel portions wrap around and merge together to form a front vertical panel. The front vertical panel of the conformal weather shield of the second preferred embodiment runs vertically downward and covers the knees, shins, ankles and feet of the driver. In contrast to the first preferred embodiment where a portion of the front fairing structure is used to cover the front portions of the driver's legs, the conformal weather shield of the second preferred embodiment comprises, in part, a front vertical panel integral with the top and side panel portions that together completely cover the legs of the driver, complementing the front fairing structure of the scooter and providing an extra measure of protection from the elements.

The conformal weather shield of the second preferred embodiment can be constructed with the alternate features of the first preferred embodiment, e.g., leg bulges, and is attached in similar ways to the scooter.

A third preferred embodiment of the present invention comprises a conformal weather shield otherwise made in accordance with the first and second preferred embodiments of the present invention and further comprising a side access flap for permitting the driver and/or passenger to easily enter and leave the conformal weather shield when mounted on a scooter or motorcycle. The side access flap comprises an open seam in at least one of the two side panel portions. The open seam extends downwardly from the driver opening and is formed by two overlapping fabric portions of the at least one side panel portion. In the third preferred embodiment the two overlapping panel portions are joined along their lateral extent by a zipper that provides a substantially weatherproof seal when zipped closed. The driver and/or passenger mount the scooter or motorcycle when the conformal weather shield is fixed to the vehicle by unzipping the zipper to allow easy access to the seat of the scooter or motorcycle. The driver and passenger then place the substantially circular openings in the top panel portion of the conformal weather shield around their lower torsos. Once the substantially circular opening has been comfortably placed about the torso, then the driver and/or passenger zips the zipper closed.

In alternate embodiments of the third preferred embodiment, the overlapping fabric portions may be closed by flaps having interlocking fabric patches or by snaps.

A fourth preferred embodiment of the present invention comprises a conformal weather shield otherwise made in accordance with the preceding embodiments and further comprising a foot covering. Mounted on the inside of each side panel portion are two foot coverings. In the fourth alternate embodiment, the foot coverings comprise a loose-fitting boot-like fabric foot covering that is open at the top and otherwise enclosed. The fabric foot coverings are made from a durable, weatherproof material, although other material may be used, e.g., neoprene or rubber. The upper portions of the fabric foot coverings are loosely attached to the inner side of the side panel portions using snaps or tabs having interlocking, VELCRO-like, fabric patches. The loose attachment permits the driver to move his feet relatively freely underneath the conformal weather shield.

In a first alternate embodiment of the fourth preferred embodiment, the fabric foot coverings further comprise a tightening means for tightening the top portion of the fabric foot covering around the leg of the driver in the vicinity of the calf. In alternate embodiments, the tightening means may comprise a drawstring or cooperating tabs having interlocking fabric patches. The tightening means maintains the fabric covering in place much like a garter. This permits the driver to use them separate and apart from the conformal weather shield, for example, to reach shelter in particularly inclement conditions.

In a second alternate embodiment of the fourth preferred embodiment, the lower bottom portion of the side panel portions are elastically retained close to the foot board of the scooter or motorcycle, but with sufficient give to permit the driver to extend his foot-covering-covered feet outside the conformal weather shield, for example, to brake the bike by contacting the ground with his feet, or to steady the scooter or motorcycle. When doing so, the feet of the driver are protected from rain or other moisture by the substantially weatherproof foot coverings.

A fifth preferred embodiment of the present invention comprises a conformal weather shield otherwise made in accordance with the preceding embodiments and further comprising an expandable panel portion incorporated in at least one of the side panel portions of the conformal weather shield. The expandable panel portion of the fifth preferred embodiment comprises an accordion-like structure. The accordion-like structure permits the side panel portion of the conformal weather shield to expand and to contract with the movements of the driver and passenger.

In alternate embodiments other construction techniques may be used to impart a degree of expandability to the side panel portion. For example, the expandable panel portion can be constructed from a weatherproof material that is even more stretchable than the weatherproof material comprising the remaining areas of the side panel portion.

A sixth preferred embodiment of the present invention comprises a conformal weather shield otherwise made in accordance with the preceding embodiments and further comprising a ventilation flap formed in the side panel portion of the conformal weather shield. The ventilation flap permits air from outside the conformal weather shield to pass underneath the conformal weather shield and into the region enclosed by the conformal weather shield. The ventilation flap also permits moisture to pass out from underneath the conformal weather shield, but prevents moisture from outside from passing into the region enclosed by the conformal weather shield. The ventilation flap improves the comfort of the driver and passenger.

A seventh preferred embodiment of the present invention comprises foul weather jackets or coats for use in combination with a conformal weather shield having a fabric gasket extending upwardly from the driver and/or passenger opening in the top panel portion. The foul weather jacket or coat of the seventh preferred embodiment is otherwise made in accordance with conventional practice, but further comprises a downwardly opening waterproof fabric gasket for operating in conjunction with the fabric gasket extending upwardly from the driver or passenger opening of the conformal weather shield.

The fabric gasket extends circularly around the torso of the foul weather jacket at about the stomach level. The top edge of the fabric gasket is either made integrally with the outer shell of the foul weather jacket, or is sewn to the jacket using weatherproof techniques. The fabric gasket extends downwardly an intermediate distance of about a few inches parallel to the outer shell of the jacket or coat. The fabric gasket and outer shell of the jacket or coat form a downwardly facing opening for accepting the upwardly extending fabric gasket of the conformal weather shield. The cooperation of the fabric gasket of the foul weather jacket or coat and the fabric gasket of the conformal weather shield further improves the weatherproof nature of the conformal weather shield.

In alternate embodiments of the seventh preferred embodiment, oppositely facing interlocking, VELCRO-like fabric patches may be stitched on the outer surface of the fabric gasket extending upwardly from the conformal weather shield, and on the inner surface of the fabric gasket of the foul weather jacket or coat. In combination the interlocking fabric patches further serve to provide a substantially weatherproof seal between the conformal weather shield and the foul weather jacket or coat.

In a further alternate embodiment of the seventh preferred embodiment, the foul weather jacket or coat has an extendable flap for increasing the protection provided to the lower extremities of the driver or passenger when they are distant from the scooter and conformal weather shield and their lower extremities are therefore no longer protected by the conformal weather shield. The retractable nature of the extendable flap also improves the comfort of the jacket for the driver and passenger since they can roll up or retract the extendable flap when protected by the conformal weather shield. The foul weather jacket thus becomes shorter and is less cumbersome underneath the conformal weather shield.

An eighth preferred embodiment of the present invention comprises a conformal weather shield otherwise made in accordance with the preceding embodiments and which further comprises an apron-like extension for use on windy or sunny days. The apron-like conformal weather shield drapes around the upper torso and arms of a driver or passenger to protect the driver or passenger from the sun or wind. In alternate embodiments of the eighth preferred embodiment, the apron-like conformal weather shield may or may not provide protection for the back of a driver or passenger. In other alternate embodiments, detachable sleeves are attached to the conformal weather shield.

Thus it is seen that the various embodiments of the present invention overcome the limitations of the prior art. In particular, one of ordinary skill in the art will understand that the conformal weather shield of the present invention represents a significant advance over conventional weather shields intended for use with scooters or motorcycles. In particular, the conformal weather shield presents an aerodynamic cross-section which minimally hinders the progress of the scooter or motorcycle when operated. Further, the conformal weather shield is intended for use with purpose-built foul weather garments which permit much greater freedom of motion of a driver or passenger than a conventional weather shields that drape downward poncho-like over the shoulders of the driver and/or passengers. This permits the driver to more freely control the operation the scooter or motorcycle in contrast to the bulky and interfering nature of conventional weather shields.

In addition, the conformal weather shield of the present invention incorporates an easy-access side entry flap that eliminates the need for removal and then reattachment of the weather shield every time the scooter or motorcycle is mounted or exited. A particularly desirable aspect of this feature is the side access flap permits quick mounting or exiting of the vehicle, thereby minimizing the exposure of the seating area to rain or other weather-borne moisture.

Further, the leg bulges and expandable panel portions of the conformal weather shield of the present invention significantly increase the comfort and protection provided by the conformal weather shield without detracting from the generally aerodynamic and streamlined cross-section of the conformal weather shield. For example, the leg bulges are smoothly faired into the side panel portions of the conformal weather shield, yet they allow the driver a measurement of side-to-side and up-and-down leg movement. This feature not only improves the comfort afforded by the conformal weather shield, it also permits a better degree of control over the scooter or motorcycle because the driver can use his legs more actively to control the vehicle.

The expandable panel portions of the conformal weather shield both improve the comfort experienced by drivers and passengers, and also provide a degree of flexible protection. For example, by placing such expandable panel portions adjacent to the thighs and knees of the driver and passenger, the driver and passenger can move their legs up-and-down and side-to-side. This is particularly useful since it permits the driver and passenger to “stretch” their legs during particularly long journeys. When placed close to the bottom edges of the side panel portions of the conformal weather shield, the expandable panel portions of the present invention permit the conformal weather shield to stretch with the driver or passenger, for example, when the driver or passenger places his or her feet on the ground. In such situation, the driver or passenger can place their feet on the conformal weather shield prior to placing them on the ground. The “give” of the side panel portion due to the expandable panel portion permits the conformal weather shield to stretch and extend down to the ground with the driver's or passenger's feet.

The foot enclosures also provide additional functionality not available in conventional weather shields. For example, in contrast to the prior art, the conformal weather shield of the present invention provides an extra measure of protection for the driver's shoes. The foot enclosures provide an extra measure of protection not only when the driver is riding the scooter or motorcycle, but also if the driver desires to depart from the vicinity of the scooter or motorcycle since the foot enclosures are detachable. Thus the driver need not carry separate additional foot protection, since exceptional foot protection is already built into the conformal weather shield.

### BRIEF DESCRIPTION OF THE FIGURES

The above and other objects and advantages of this invention will be apparent upon consideration of the following detailed description, taken in conjunction with the accompanying drawings in which like characters refer to like elements throughout and in which:

FIG. 1 is a top plan view of a conformal weather shield 100 made in accordance with a first preferred embodiment of the present invention;

FIG. 2 is a top plan view of a conformal weather shield 100 having an alternate first attachment means 140 made in accordance with the present invention;

FIG. 3 is a top plan view of a conformal weather shield 100 having yet another alternate first attachment means 140 made in accordance with the present invention;

FIG. 4 is a top plan view of a conformal weather shield 100 having a further alternate first attachment means 140 made in accordance with the present invention;

FIG. 5 is a side view of the conformal weather shield 100 made in accordance with the first preferred embodiment of the present invention attached to a scooter;

FIG. 6 is a front view of the conformal weather shield 100 made in accordance with the first preferred embodiment of the present invention attached to a scooter;

FIG. 7 is a top view of the conformal weather shield 100 made in accordance with the first preferred embodiment of the present invention attached to a scooter;

FIG. 8 is a side view of a scooter having an interlocking, VELCRO-like strip comprising a portion of the second attachment means of the present invention attached to the front fairing structure of the scooter;

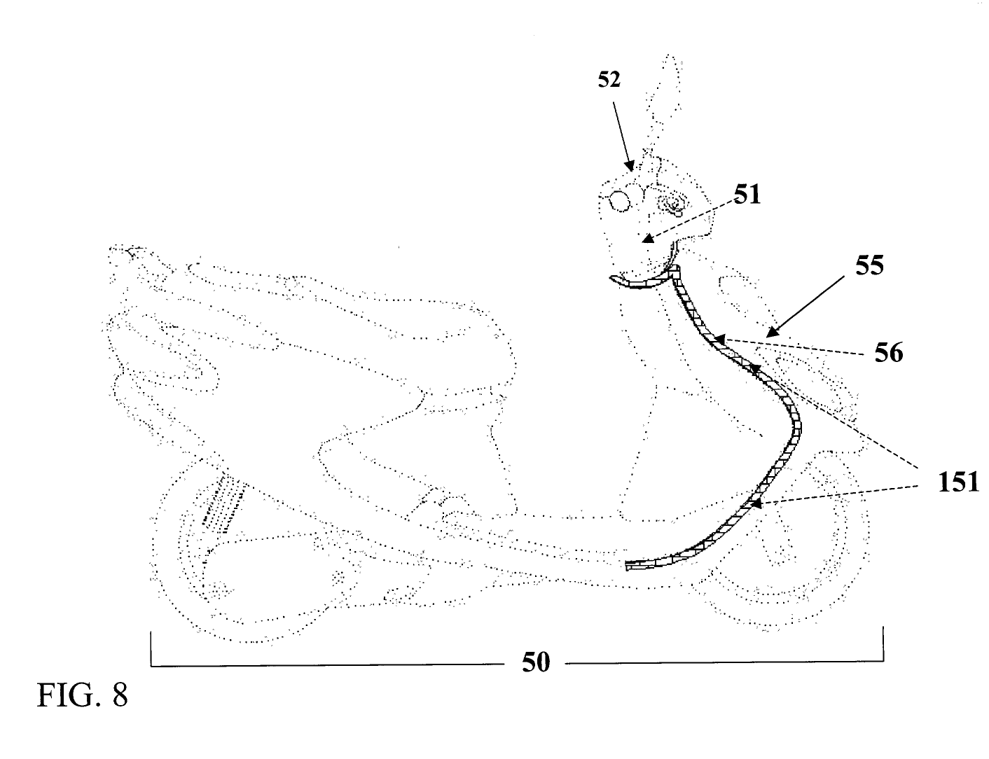

FIG. 9 depicts an alternate second attachments 150 made in accordance with the present invention for attaching the conformal weather shield to a scooter 50;

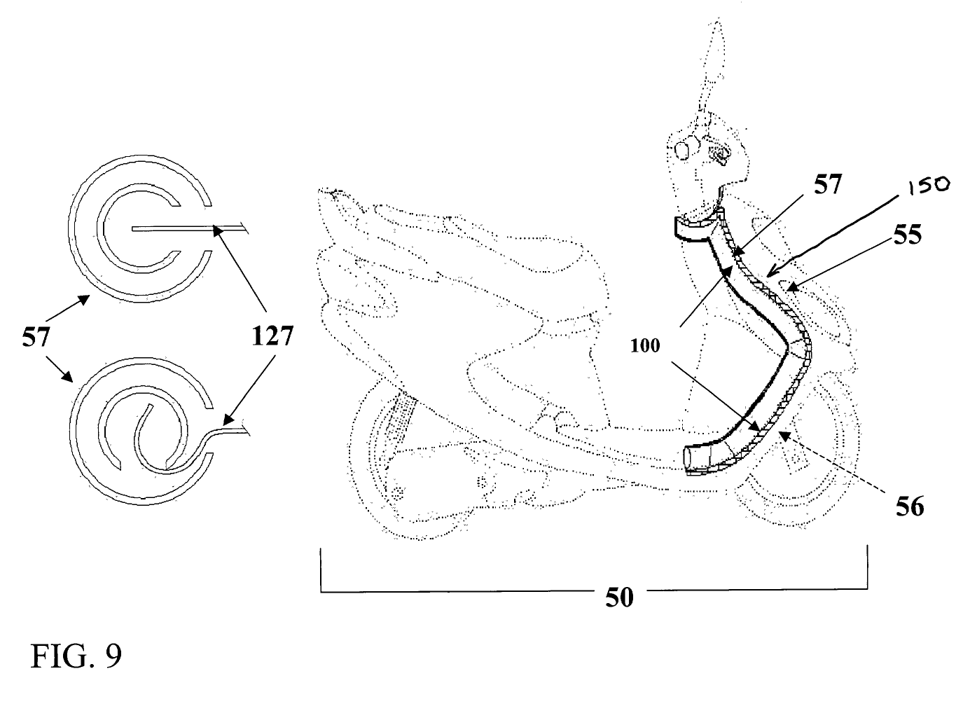

FIG. 10 depicts the alternate second attachment means depicted in FIG. 9 holding the conformal weather shield in place during a deployment operation;

FIG. 11 depicts a close-up side view of a scooter showing the mounting plates and storage boot 160 of yet another second attachment means attached to the front fairing structure of the scooter;

FIG. 12 depicts a side view of the conformal weather shield 100 being unrolled from the storage boot 160 of the alternate second attachment means depicted in FIG. 11;

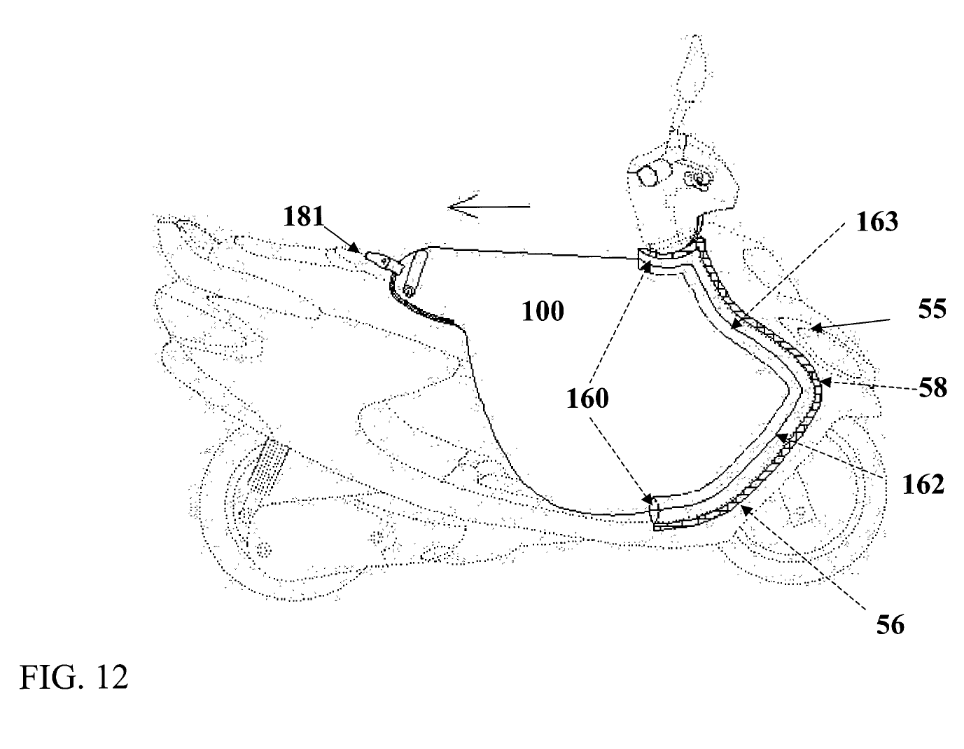

FIG. 13 depicts a side view of the conformal weather shield 100 being stored in the storage boot 160 of the alternate second attachment means depicted in FIG. 11;

FIG. 14 depicts a top plan view of a conformal weather shield 100 comprising, in part, a further alternate second attachment means;

FIG. 15 depicts a side view of the alternate second attachment means depicted in FIG. 14 attaching the conformal weather 100 to the scooter 50;

FIG. 16 depicts a side view of the conformal weather shield attached to a scooter 50 by an alternate third attachment means 170;

FIG. 17 depicts a side view of the conformal weather shield attached to a scooter 50 by yet another alternate third attachment means 170;

FIG. 18 depicts an alternate fourth attachment means comprising, in part, a storage structure 190 for storing the conformal weather shield 100, wherein the fourth attachment means attaches the rear top panel portion of the conformal weather shield to the rear seat structure of the scooter;

FIG. 19 depicts the details of construction of the storage boot 191 of the fourth attachment means depicted in FIG. 18;

FIG. 20 depicts the conformal weather shield of the present invention being stored in the storage boot 191 of the alternate fourth attachment means depicted in FIG. 18;

FIG. 21 depicts yet another fourth attachment means comprising a dual purpose turn crank storage system 200 for attaching the conformal storage shield to the scooter 50 and for storing the conformal weather shield when not in use;

FIG. 22 depicts a side view of the turn crank storage system in operation stowing the conformal weather shield 100;

FIGS. 23 and 23A depict the turn crank storage assembly 200 and storage boot 191, respectively, located in a storage compartment 65 positioned underneath the seat of the scooter 50;

FIG. 24 depicts a top view of the details of the driver and passenger openings 220 and cover panel 230 of the first preferred embodiment of the present invention;

FIG. 25 depicts a side view of the conformal weather shield 100 attached to a scooter with the cover panel 230 covering the driver and passenger openings of the conformal weather shield;

FIG. 26 depicts a side view of the conformal weather shield having fabric gaskets 240 extending upward from driver and passenger openings 220 made in accordance with an alternate embodiment of the first preferred embodiment;

FIG. 27 depicts a top plan view of an alternate conformal weather shield having water channels 125 formed in the top panel portion and side panel portions of the conformal weather shield;

FIG. 28 depicts an alternate conformal weather shield having water channels 125 formed in the top panel portion and side panel portions and mounted to a scooter 50;

FIG. 29 depicts a side view of an alternate conformal weather shield having leg bulges 250 formed in the side panel portions 120;

FIG. 30 depicts a front view of an alternate conformal weather shield 100 having leg bulges 250 formed in the side panel portions 120;

FIG. 31 depicts a side view of the conformal weather shield made in accordance with a first preferred embodiment of the present invention and attached to a motorcycle;

FIG. 32 depicts a top plan view of a conformal weather shield 100 made in accordance with a second preferred embodiment of the present invention and comprising, in part, a vertically-extending front panel;

FIG. 33 depicts a side view of the conformal weather shield of the second preferred embodiment attached to a scooter 50;

FIG. 34 depicts a top plan view of a conformal weather shield 100 made in accordance with a second preferred embodiment of the present invention and comprising, in part, an alternate second attachment means;

FIG. 35 depicts a top plan view of a conformal weather shield 100 having side access flaps 270 made in accordance with a third preferred embodiment of the present invention;

FIG. 36 depicts a side view of a conformal weather shield having a closed side access flap 270, wherein the conformal weather is made in accordance with a third preferred embodiment of the present invention;

FIG. 37 depicts a driver of a scooter exiting the scooter through the side flap 270 of a conformal weather shield otherwise made in accordance with a third preferred embodiment of the present invention;

FIG. 38 depicts a top plan view of a conformal weather shield 100 having foot coverings 290 and made in accordance with a fourth preferred embodiment of the present invention;

FIG. 39 depicts a side view of a conformal weather shield having foot coverings 290 mounted to a scooter and made in accordance with a fourth preferred embodiment of the present invention;

FIG. 40 depicts the details of construction of the foot coverings 290 made in accordance with a fourth preferred embodiment of the present invention;

FIG. 41 depicts the driver of a scooter extending his foot covering 290—covered foot beyond the conformal weather shield 100;

FIG. 42 depicts an alternate expandable foot covering 310 otherwise made in accordance with a fourth preferred embodiment of the present invention;

FIG. 43 depicts a conformal weather shield 100 further comprising an expandable side panel portion 320 made in accordance with a fifth preferred embodiment of the present invention;

FIG. 44 depicts an alternate expandable side panel portion 320 made in accordance with a fifth preferred embodiment of the present invention;

FIG. 45 depicts a top plan view of a conformal weather shield having a ventilation opening 330 and made in accordance with a sixth preferred embodiment of the present invention;

FIG. 46 depicts a side view of a conformal weather shield having a ventilation opening 330 in its side panel portions 120, wherein the conformal weather shield of the sixth preferred embodiment is attached to a scooter 50;

FIG. 47 depicts a foul weather jacket made for use in combination with a conformal weather shield 100, wherein the foul weather jacket is made in accordance with a seventh preferred embodiment of the present invention;

FIG. 48 depicts an alternate foul weather jacket having an expandable flap otherwise made in accordance with a seventh preferred embodiment of the present invention;

FIG. 49 depicts a foul weather jacket made in accordance with a seventh preferred embodiment operating in combination with a conformal weather shield having upwardly extending fabric gaskets;

FIG. 50 depicts a top view of an apron-like conformal weather shield made in accordance with an eighth preferred embodiment of the present invention; and

FIG. 51 depicts a side view of an apron-like conformal weather shield made in accordance with an eighth preferred embodiment of the present invention attached to a scooter.

### DETAILED DESCRIPTION OF THE PREFERRED EMBODIMENTS

I. First Preferred Embodiment

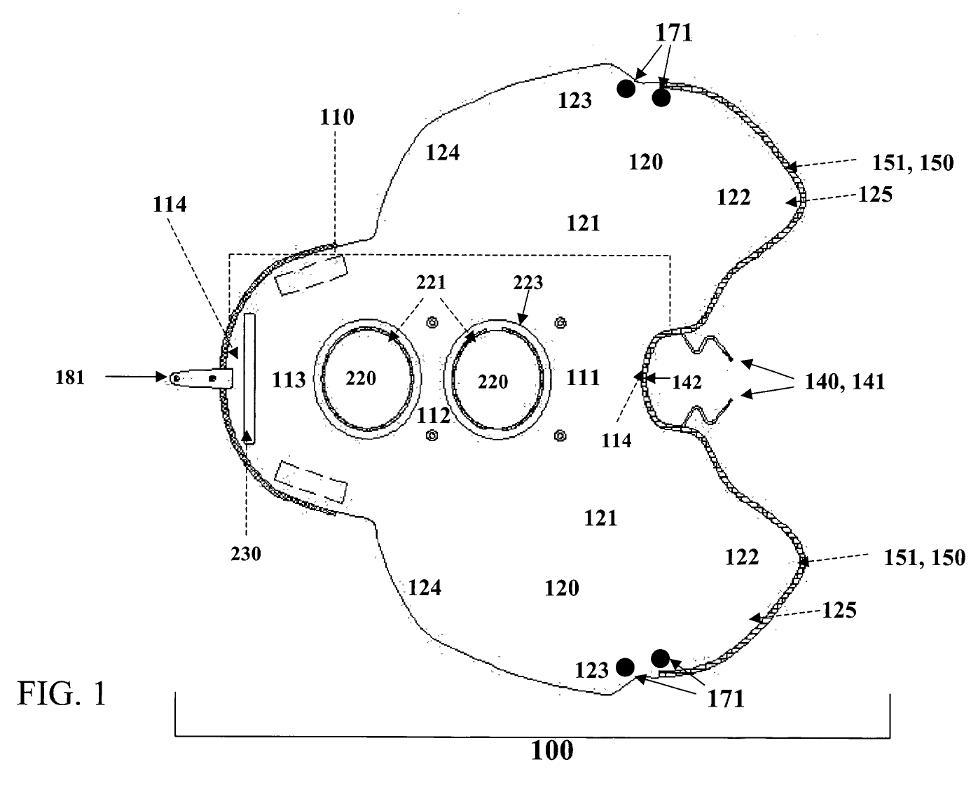

A conformal weather shield 100 made in accordance with a first preferred embodiment of the present invention is depicted in FIG. 1. The conformal weather shield 100 comprises a top panel portion 110 and two side panel portions 120. The top panel portion 110 has a front top panel portion 111; an intermediate top panel portion 112; and a rear top panel portion 113. Each side panel portion 120 has a top edge 121; a front edge 122; a bottom edge 123; and a rear edge 124. The conformal weather shield 100 of the present invention in various embodiments can be made from an integral piece of fabric, or from several or more pieces of fabric stitched or chemically welded together. The conformal weather shield generally is made from flexible, stretchable, sturdy and waterproof material that will provide long life for the conformal weather shield. There are a number of suitable fabrics from which the conformal weather shield 100 could be constructed including, but not limited to, nylon spandex fabric; ripstop nylon; polyester fabrics; mesh fabric; GORE-TEX, and other materials which resist the effects of weather. In the embodiment depicted in FIG. 1, the conformal weather shield 100 is made from a single piece of flexible, stretchable, sturdy and waterproof material.

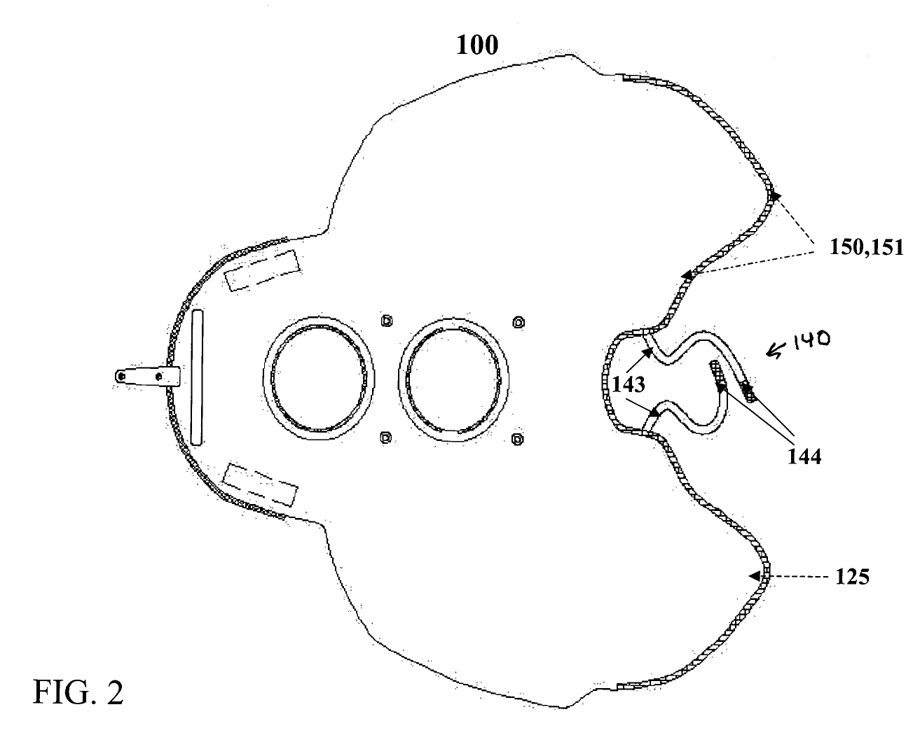

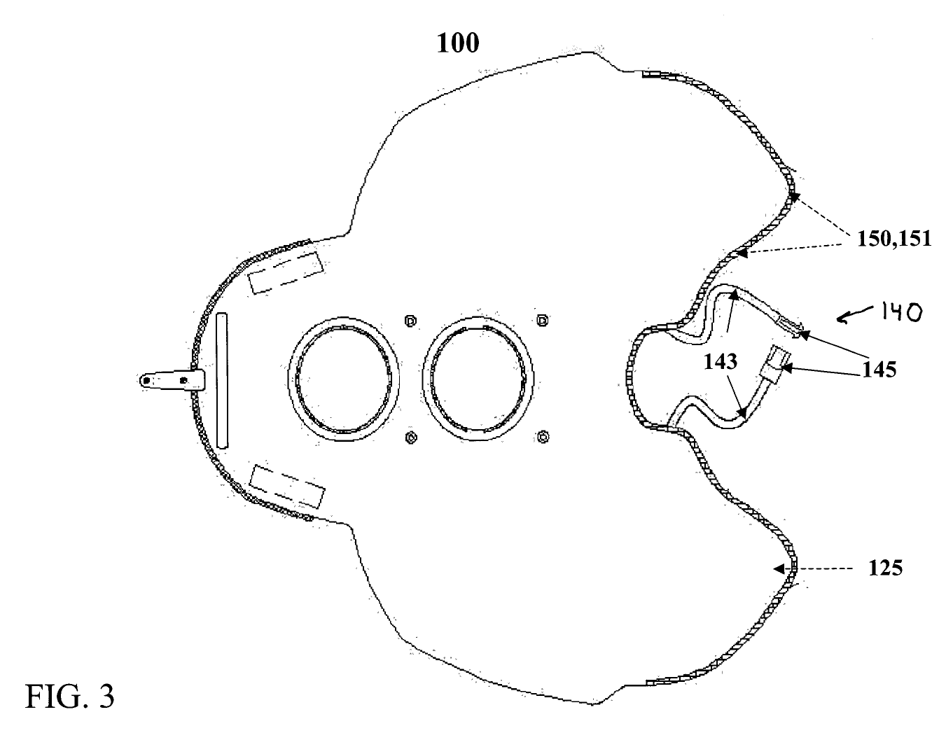

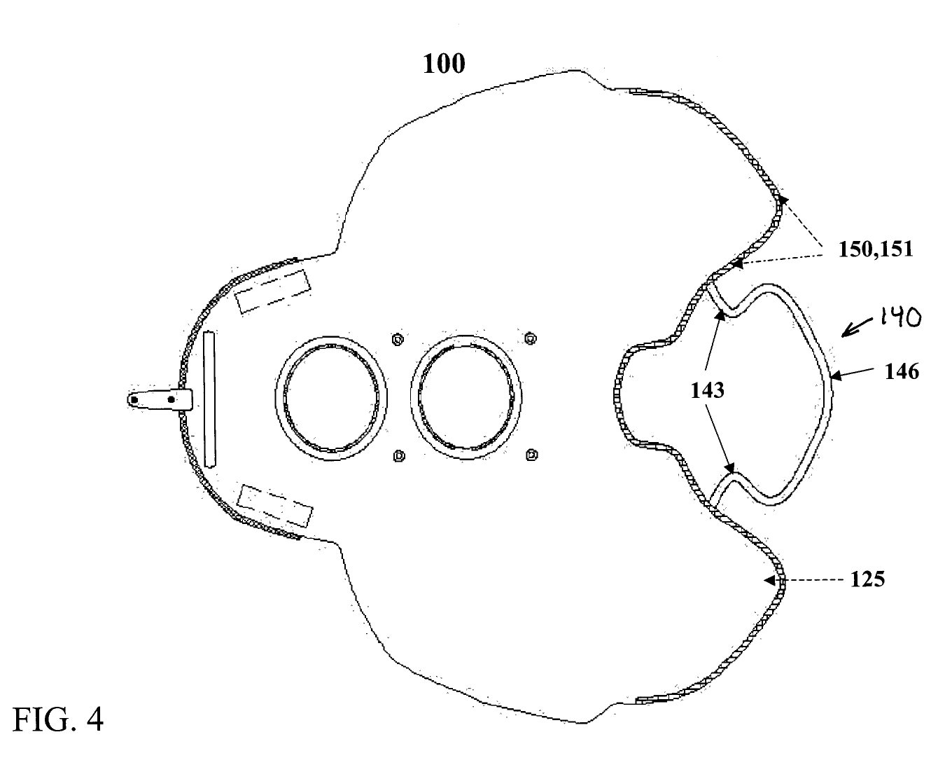

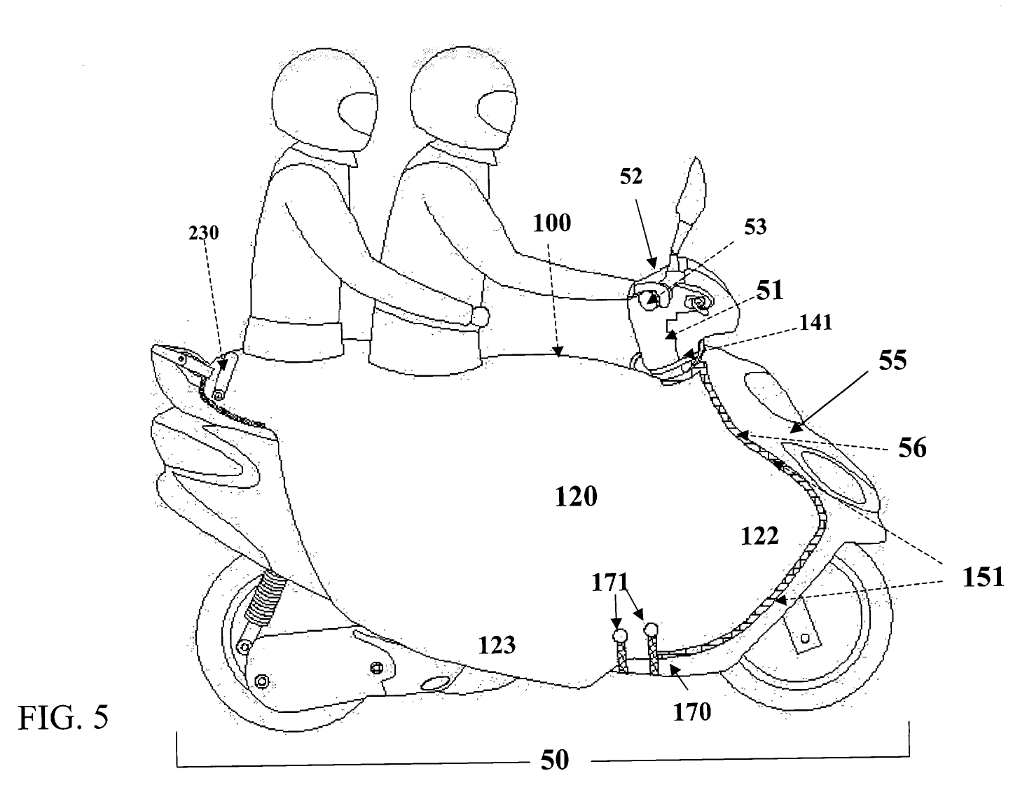

The conformal weather shield 100 further comprises several attachment means for securely mounting the conformal weather shield to a scooter as depicted in FIGS. 5, 6 and 7. A first attachment means 140 depicted in FIG. 1 comprises a drawstring 141 for attaching the front top panel portion 111 of the conformal weather shield to the steering column 51 of the scooter 50 generally in the vicinity of, and beneath, the instrument panel 52 as depicted in FIGS. 5-7. Although a drawstring 141 passing through a tube 142 formed in the edge 114 of the front top panel portion 111 comprises the first attachment means depicted in FIG. 1, other means may be used for securing this portion of the conformal weather shield 100 to the scooter 50. For example, two straps 143 having interlocking, VELCRO-like fabric patches may be used; or two straps 143 having snaps at each end may be used 145; or a loop 146 made from bungee-type cord may be used. These alternate embodiments are depicted in FIGS. 2, 3 and 4. As shown in the first alternate embodiment of FIG. 2, two fabric straps 143 extend outward from either side front top panel portion 111. At the tag end of each fabric strap 143 are interlocking, VELCRO-like fabric patches 144. In the second alternate embodiment depicted in FIG. 3, there are depicted the respective elements of a snap enclosure 145. Any of the snap enclosures referred to herein may further comprise an adjustment feature for adjusting the length the fabric strap to which it is attached so that a tight connection may be achieved. In the third alternate embodiment depicted in FIG. 4, a loop 146 of bungee-type cord is depicted.

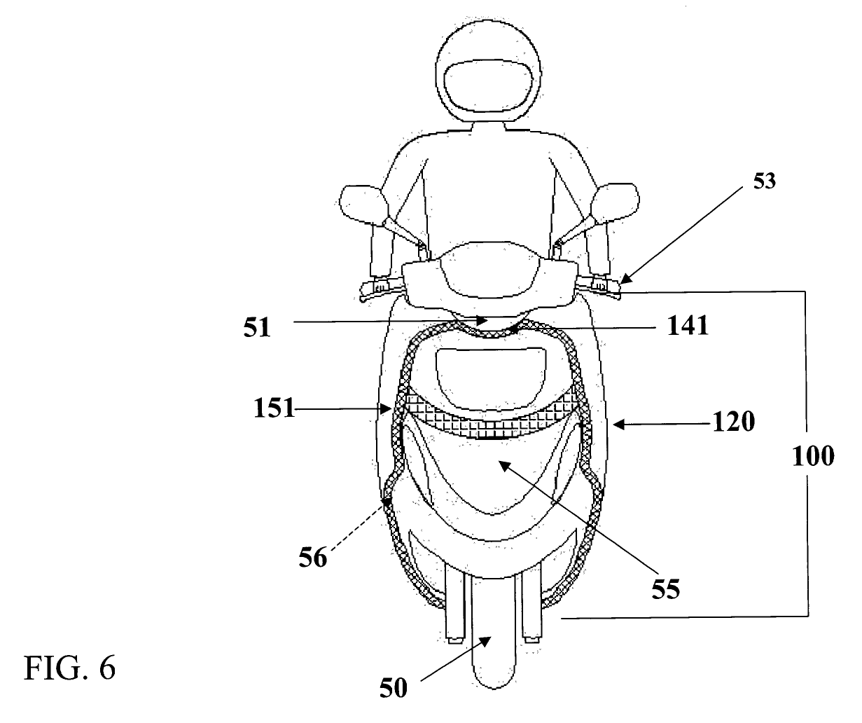

The first attachment means is depicted in operation in FIGS. 5 and 6 attaching the conformal weather shield 100 to the scooter 50. The tag ends of the drawstrings 141 are looped around the steering column 51 of the scooter 50 in the vicinity of the instrument panel 52 and handlebars 53. The tag ends of the drawstrings 141 are then tied off to securely attach the conformal weather shield to the scooter 50. The alternate attachment means depicted in FIGS. 2-4 are attached in a similar manner by passing the straps 143 around either side of the steering column, or by stretching and passing the loop 146 over the handle bars 53 and instrument panel 52

A second attachment means 150 for attaching the front edge 122 of the side panel portions 120 of the conformal weather shield 100 to a scooter 50 is depicted in FIG. 1, and is shown in operation in the side view of FIG. 5 and the front view of FIG. 6. The second attachment means 150 of the first preferred embodiment comprises strips 151 having interlocking, VELCRO-like fabric patches that are stitched to the inside edge 125 of each front edge 122 of the side panel portions. The inside edges 125 are shown as the turned-up portions in FIG. 1. The inside edge 125 faces towards the scooter 50 when the conformal weather shield is installed. The strip having an interlocking, VELCRO-like fabric patch is intended to attach to a corresponding strip similarly having an interlocking fabric patch mounted permanently to the edge 56 of the front fairing structure 55 of the scooter 50.

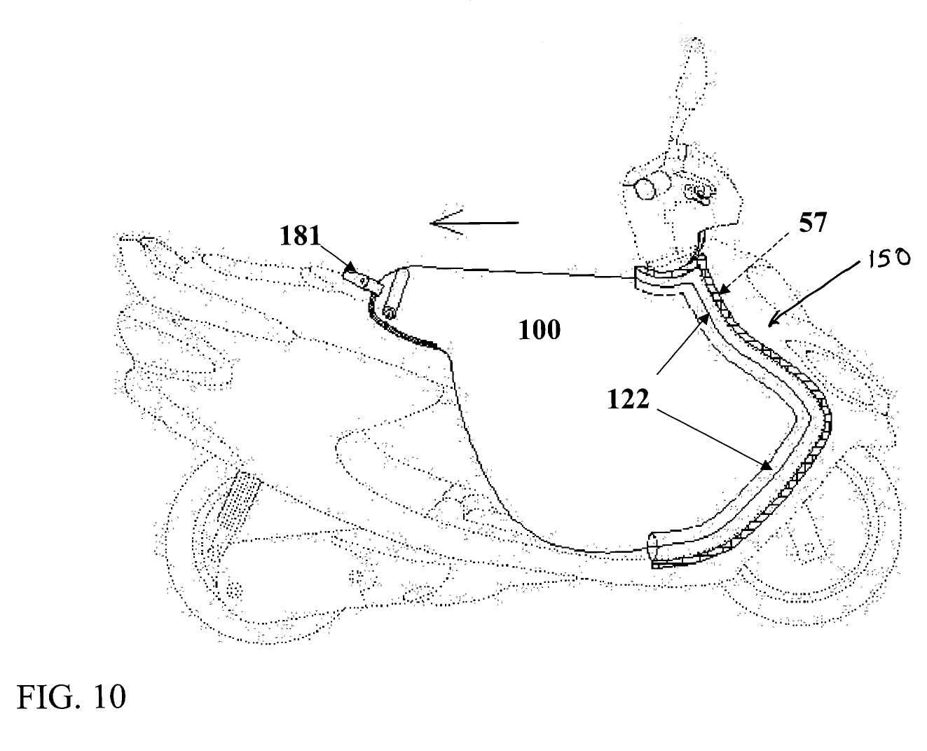

In alternate embodiments of the first preferred embodiment, the second attachment means 150 may comprise an elastic material 127 stitched to the front edge 122 of the side panel portion and intended to cooperate with cleat-like structures 57 attached to the edge 56 of the front fairing structure 55 of the scooter 50. During an installation procedure illustrated in FIG. 10, the front edges 122 of the side panel portions are stretched over the cleat-like structures 57. The elastic material wraps around the cleat-like structures 57 when under tension, and maintains the conformal weather shield 100 in place.

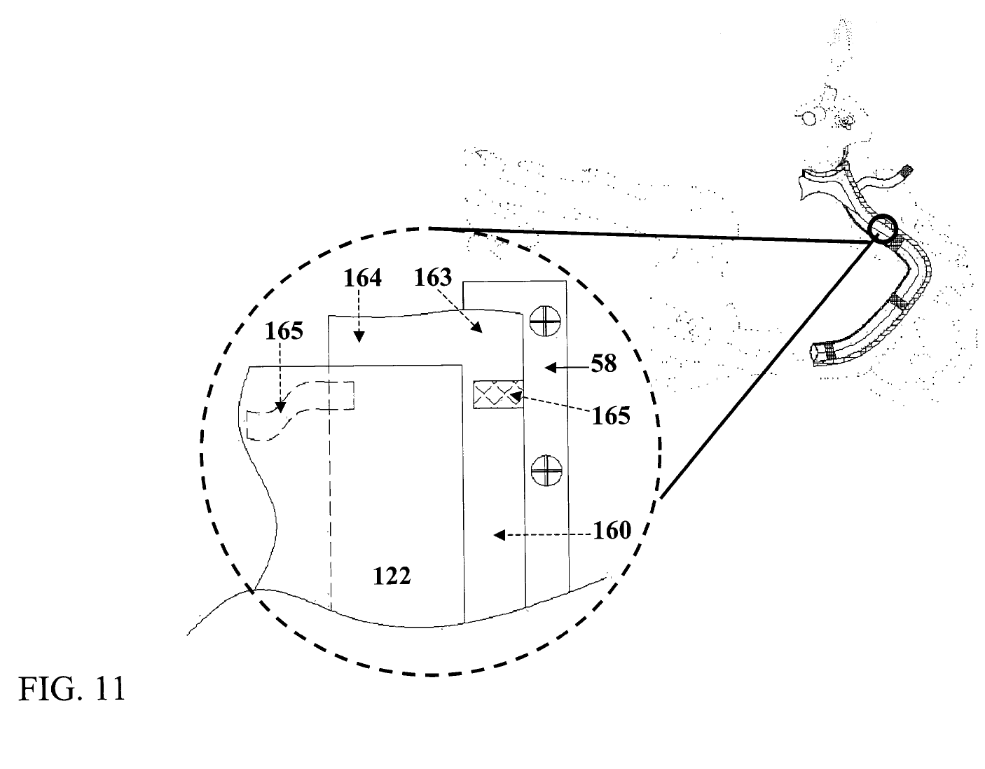

In a still further alternate embodiment of the first preferred embodiment, the second attachment means comprises a dual-purpose mounting plate and storage boot 160. The front edges 122 of the side panel portions 120 of the conformal weather shield are permanently attached to the edges 56 of the front fairing structure 55 of the scooter 50 using screw plates 58. Also attached to the front fairing structure 55 of the scooter 50 by the screw plates 58 is a storage boot 160. The storage boot 160 is made from a flexible, durable and weatherproof fabric, and forms a tube-like structure that is open along one side as shown in FIG. 11. The closed portion 163 of the tube-like structure opposite to the opening 164 is held in place by the screw plates 58. The two edges 165 that form the opening in the tube-like structure of the storage boot 162 are sealed using interlocking, VELCRO-like fabric patches, zippers or snaps.

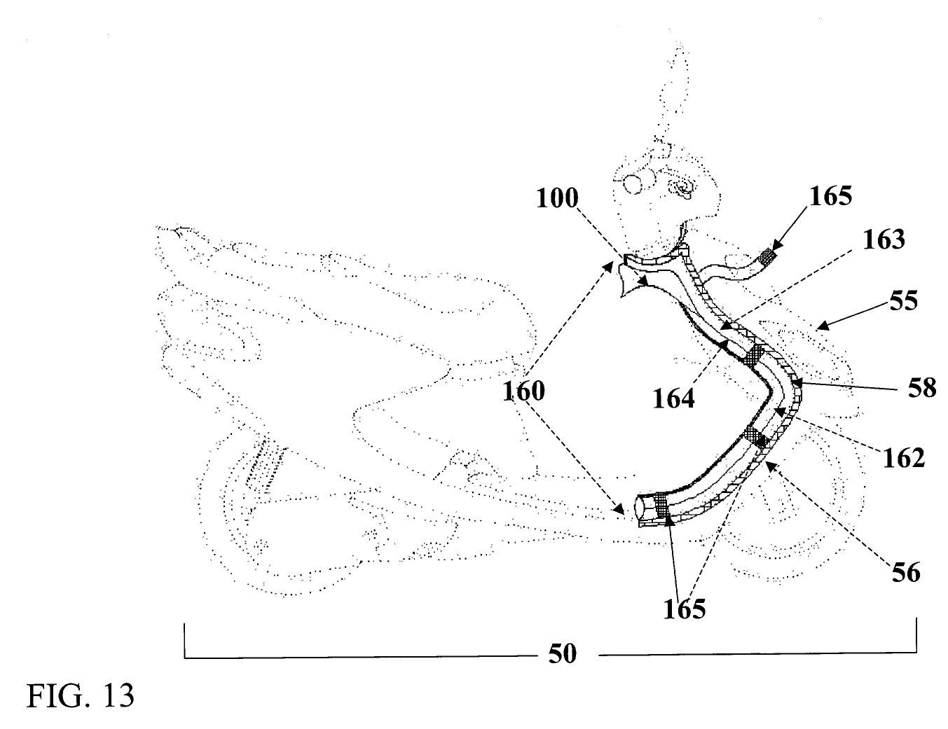

When it is desired to store the conformal weather shield 100 of this particular embodiment, it is rolled up and towards the front of scooter until the rolled-up conformal weather shield is immediately adjacent the opening in the tube-like structure of the storage boot 162 as shown in FIG. 13. The edges 165 that form the opening in the storage boot 162 are then slipped around the rolled-up conformal weather shield and sealed using strips having interlocking fabric patches; snaps or zippers, as shown in FIG. 13.

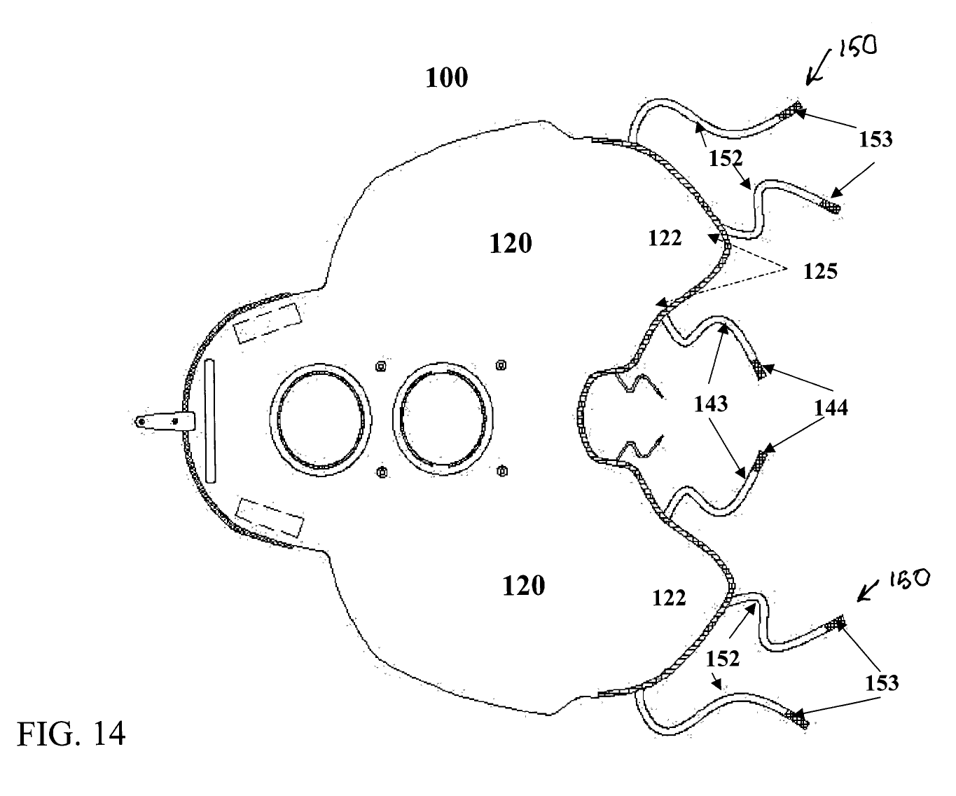

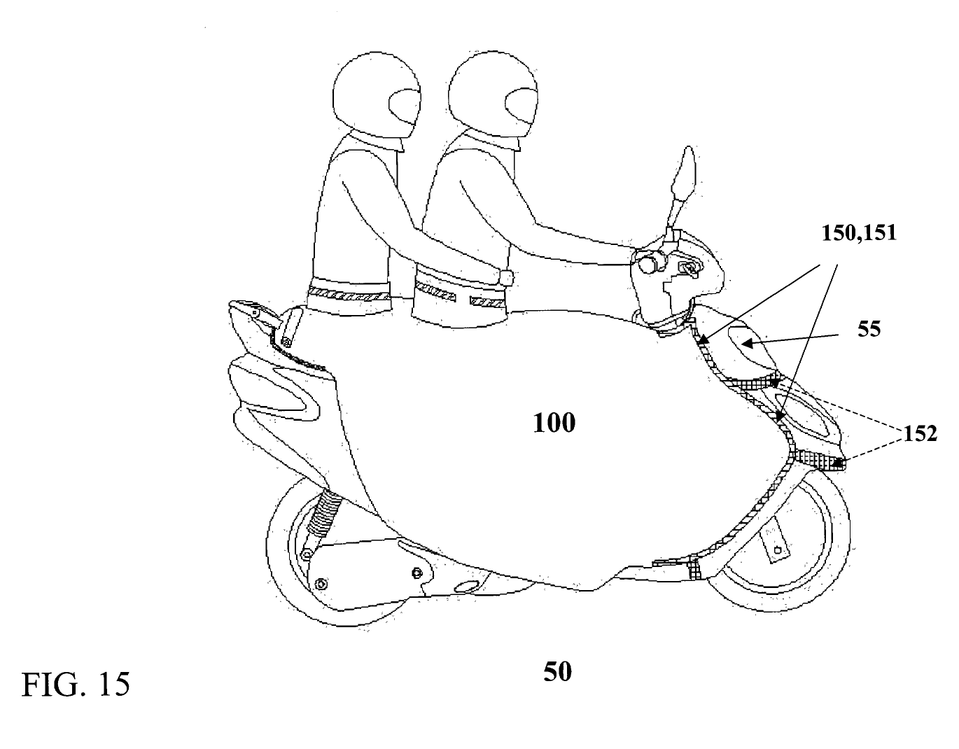

A further alternate second attachment means depicted in FIGS. 14 and 15 can be used either individually or in combination with the foregoing second attachment means to securely mount the front edges 122 of the side panel portions 120 to the front fairing structure 55 of the scooter 50. The alternate second attachment means comprises fabric straps 152 having interlocking, VELCRO-like fabric patches 153 stitched to their tag ends. The fabric straps 152 are wrapped around the front fairing structure as illustrated in FIG. 15, and the interlocking fabric patches 153 are used to secure the fabric straps 152 together and in turn secure the front edges 122 of the side panel portions 120 to the front fairing structure 55 of the scooter 50.

A third attachment means 170 for mounting the conformal weather shield 100 to a scooter 50 is shown at the bottom edges 123 of the side panel portions 120 of the conformal weather shield 100. The third attachment means 170 in the first preferred embodiment depicted in FIG. 1 comprises at least two holes 171 formed in the bottom edges 123 of side panel portions 120. The holes 171 are intended to operate in cooperation with drawstrings or chains and a lock. During a mounting operation, the bottom edges 123 are stretched underneath the scooter and held in close proximity so that a drawstring can be drawn through the two respective holes 171 formed in each side panel portion, and then knotted to securely attach this area of the conformal weather shield, as depicted in FIG. 5.

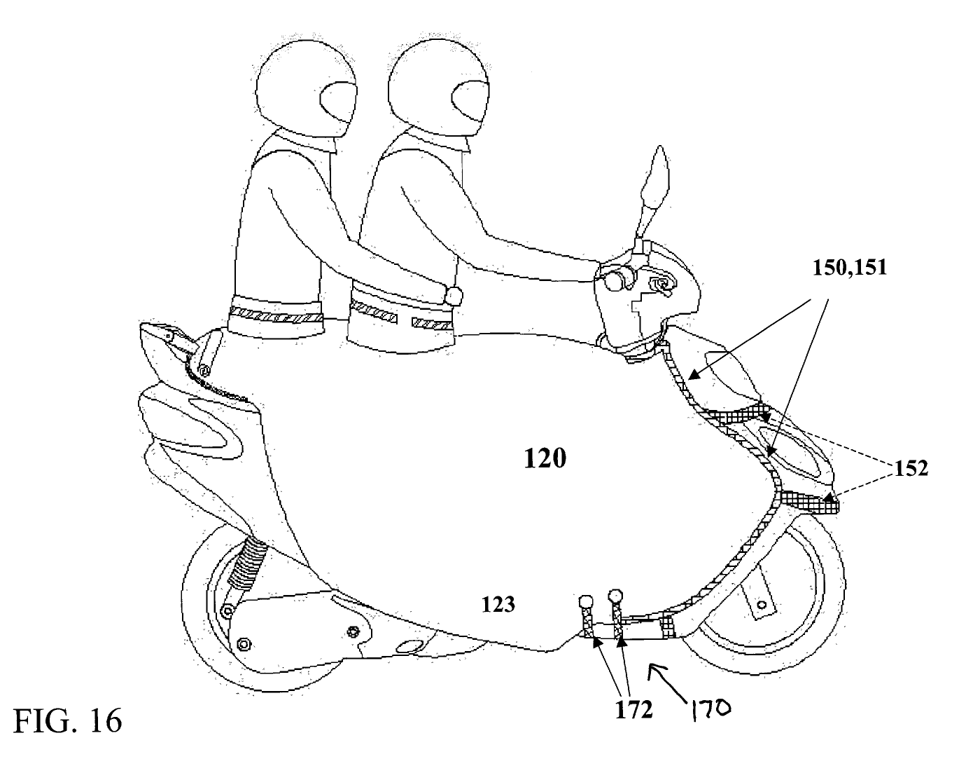

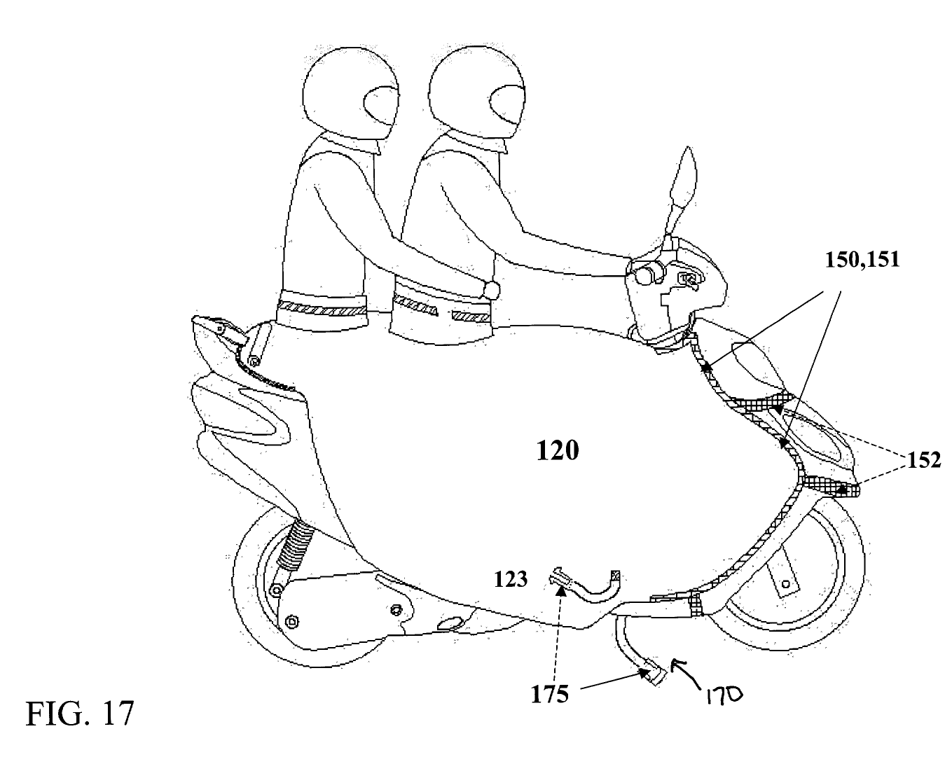

In alternate embodiments of the first preferred embodiment depicted in FIGS. 16 and 17, the third attachment means comprises straps having interlocking, VELCRO-like fabric patches 172, or snap-covered flaps 175 attached to each bottom edge 123 of each side panel portion, respectively.

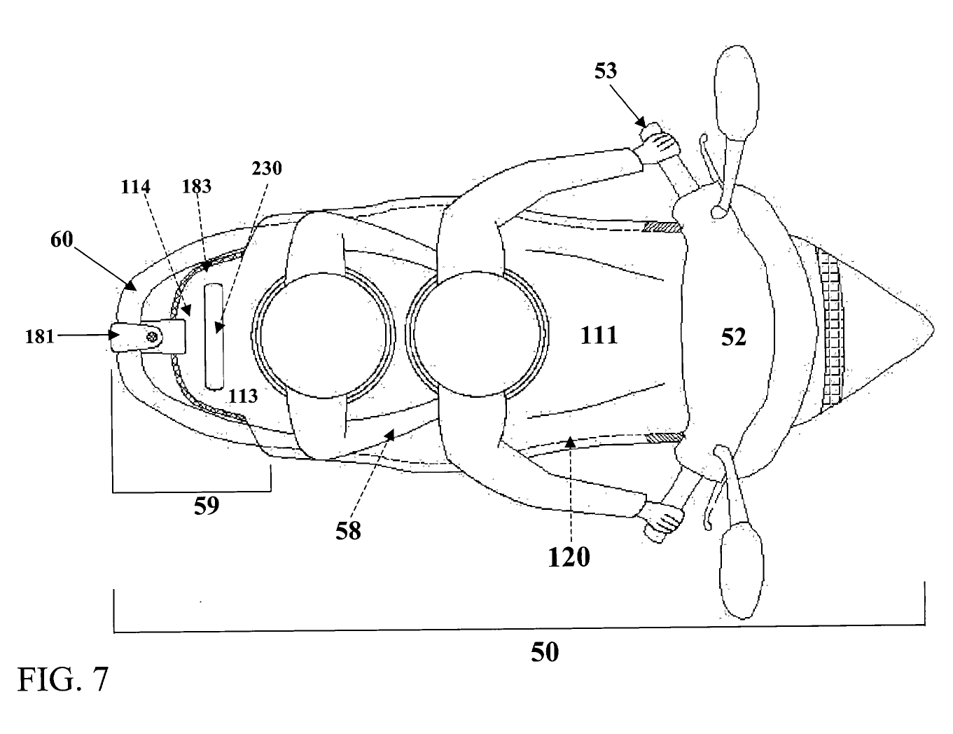

A fourth attachment means 180 made in accordance with the first preferred embodiment of the present invention and used for attaching the conformal weather shield to the scooter is also depicted in FIG. 1. The fourth attachment means 180 operates to attach the rear top panel portion 113 of the conformal weather shield 100 to the scooter 50 in the general vicinity of the rear portion 59 of the scooter seat 58. In the first preferred embodiment depicted in FIG. 1, the fourth attachment means 180 comprises a fabric loop 181 that extends rearward from the rear top panel portion 113 of the conformal weather shield 100. Attached to the fabric loop 181 are the respective elements of a snap enclosure. The fabric loop 181 is passed through an enclosed opening 59 formed by the passenger handle 60 on the scooter 50, as shown in the top view of FIG. 7. In alternate embodiments the fourth attachment means further comprises an elastic material 183 stitched to the rear edge 114 of the rear top panel portion 113 of the conformal weather shield 100. During mounting operations, the elastic material 183 is stretched over the rear portion 59 of the scooter seat 58 and then released. The elastic material 183 forms a substantially weatherproof seal around the seat and thereby keeps the rear torso of the driver or passenger dry.

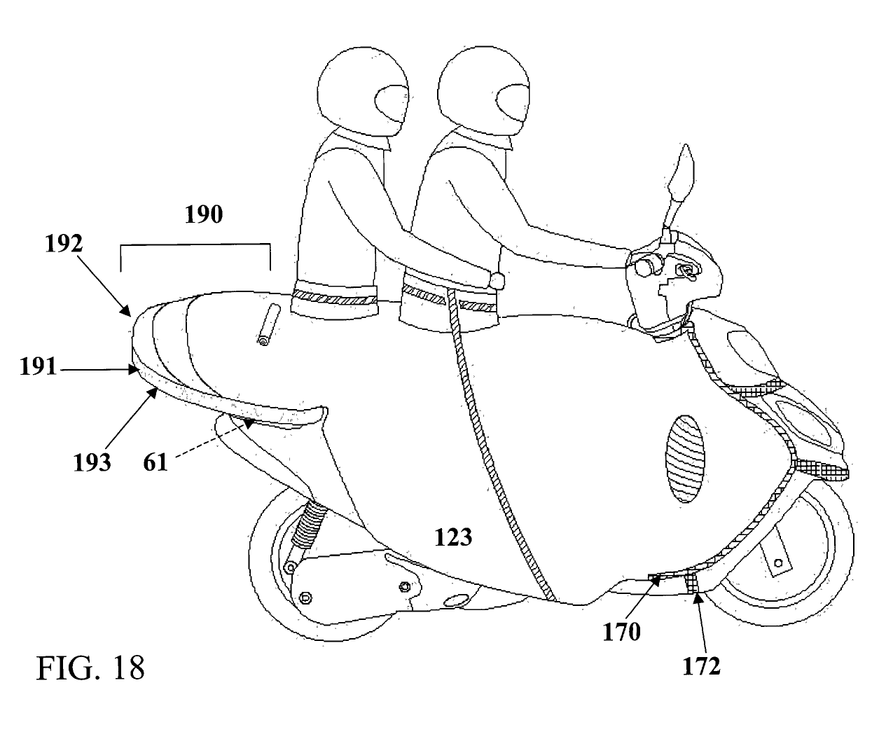

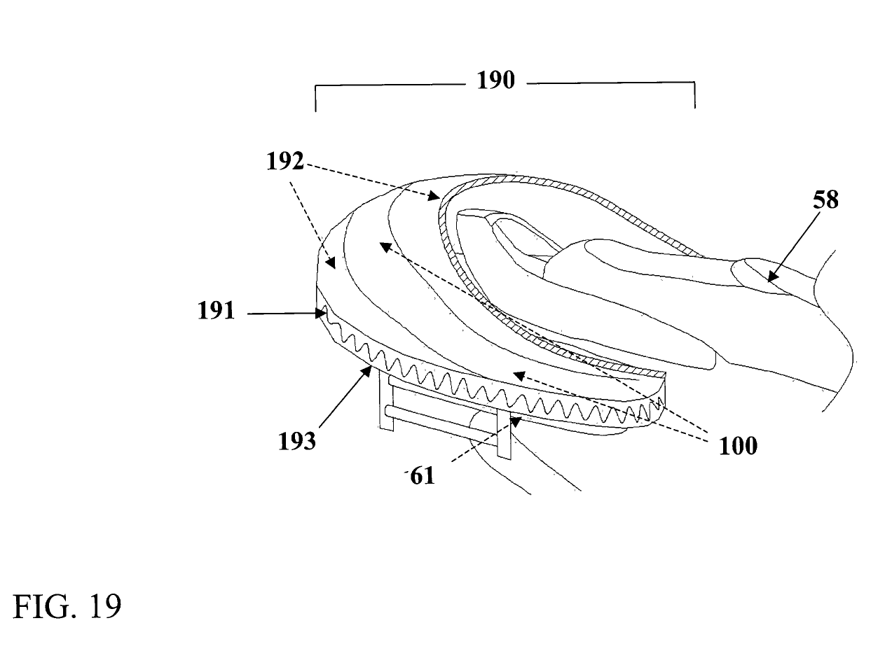

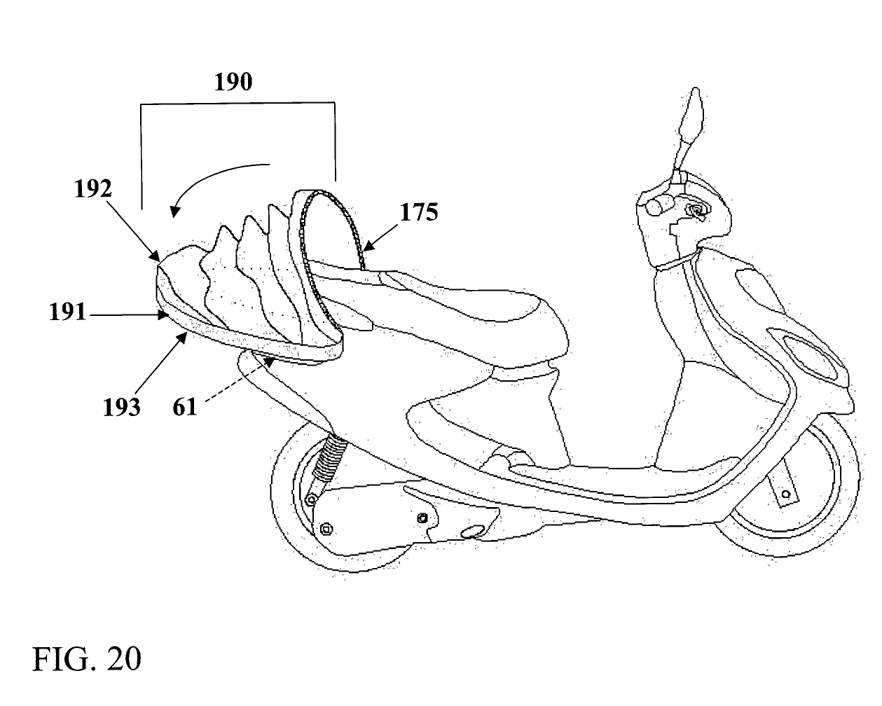

In an alternate embodiment depicted in FIG. 18, the fourth attachment means may comprise a dual-purpose attachment and storage structure 190. In this particular alternate embodiment, the rear top panel portion 113 is mounted to the scooter in the vicinity of the rear portion of the seat structure using one or more screw plates 61. Also mounted to the scooter using screw plates 61 is a fabric boot 191 of tubular construction having an open seam 192 running along its lateral extent. The details of the storage boot are depicted in FIG. 19. The side 193 of the fabric boot 191 opposite the lateral opening 192 is attached to the scooter using the one or more screw plates 61. The opposite edges forming the lateral seam in the fabric boot have oppositely-facing interlocking, VELCRO-like strips for closing the fabric boot once the conformal weather shield 100 has been stowed in the fabric boot. The conformal weather shield being rolled back towards the storage boot 191 is depicted in FIG. 20. Other means may be used to seal the seam of the fabric boot, for example, a zipper or multiple snaps.

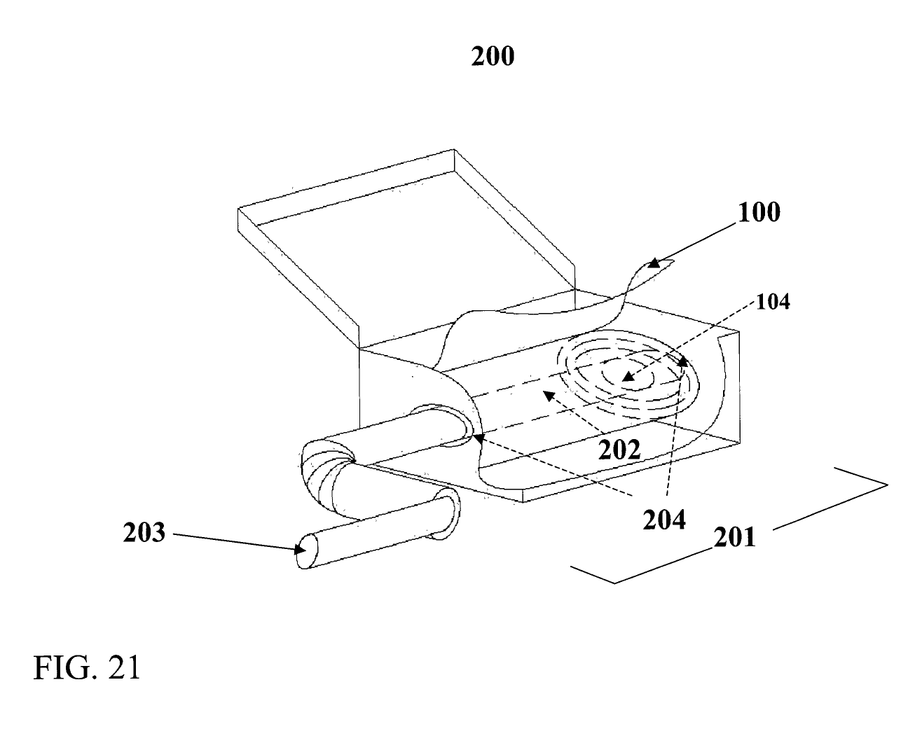

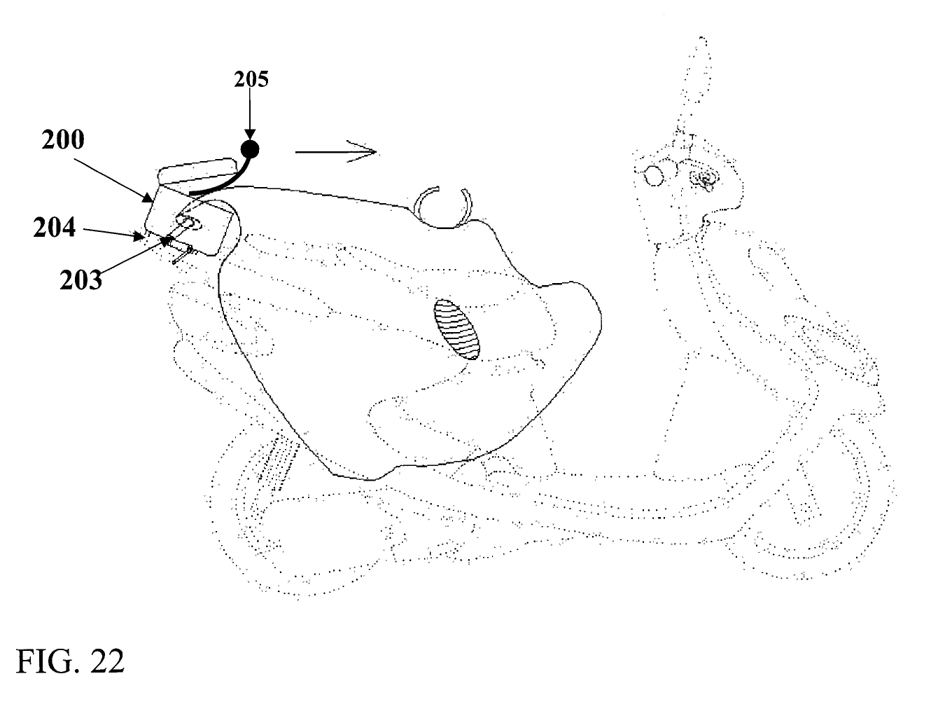

In yet another alternate embodiment, the fourth attachment means comprises a turn crank storage system 200 comprising a turn crank 201 having a central spindle 202; a handle 203 for rotating the central spindle; and a mounting plate 204 for attaching the turn crank assembly to the scooter as depicted in FIG. 21. The turn crank storage system 200 is mounted on the exterior of the scooter in the vicinity of the rear portion 59 of the seat structure 58 as depicted in FIG. 22. The edge 114 of the rear top panel portion 113 is attached to the central spindle 202 of the turn crank storage system 200 serving the first purpose of attaching this portion of the conformal weather shield to the scooter. During storage operations, the remaining attachment means are released, and the driver turns the handle 203 of the turn crank storage system. The turning motion rolls up the conformal weather 100 shield into a compact bundle for storage, and ties 205 are used to secure the conformal weather shield so that it does not work loose.

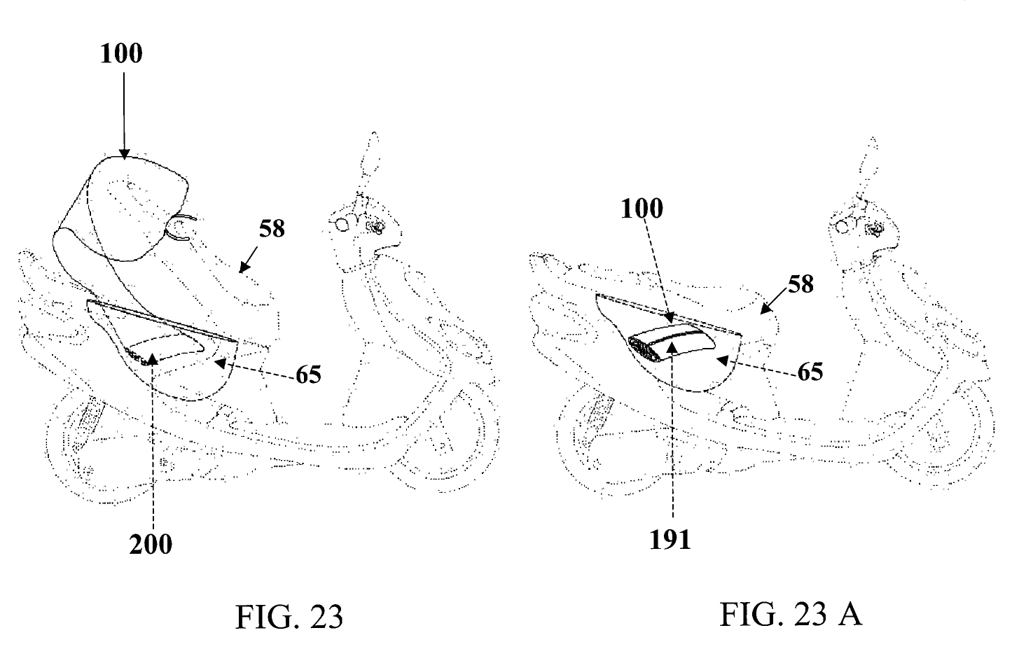

In still further alternate embodiments, variants of the preceding two embodiments—the turn crank storage assembly and the rear storage boot—are positioned underneath the seat structure in a storage compartment 65, as depicted in FIGS. 23 and 23A.

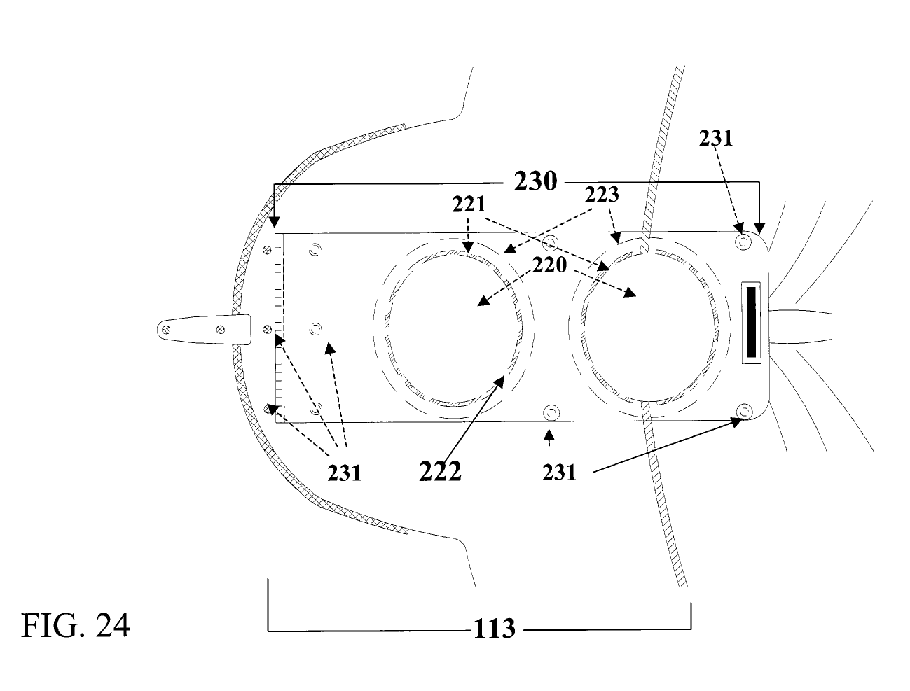

The intermediate top panel 112 of the conformal weather shield further comprises two substantially circular openings 220 for accommodating the driver and passenger of the scooter as depicted in FIGS. 1 and 24. The substantially circular openings 220 of the conformal weather shield have a tightening means 221 for tightening the fabric of the conformal weather shield forming the openings 220 snugly around the passenger and driver. The tightening means 221 of the first preferred embodiment comprises an elastic material 222 stitched to the edge 223 of the circular openings 220. The circular openings are stretched by the driver and passenger during mounting operations.

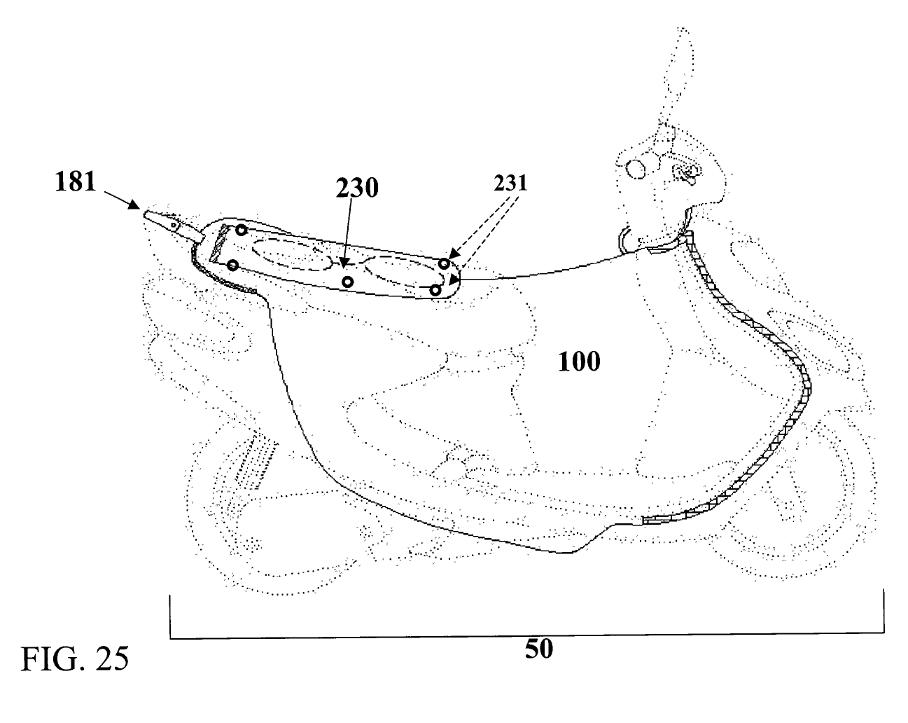

When not in use, the openings 220 are covered by a detachable cover panel 230 sized appropriately to cover the circular openings and attached to the intermediate top panel portion 112 of the conformal weather shield 100 using snaps 231 as depicted in FIG. 25.

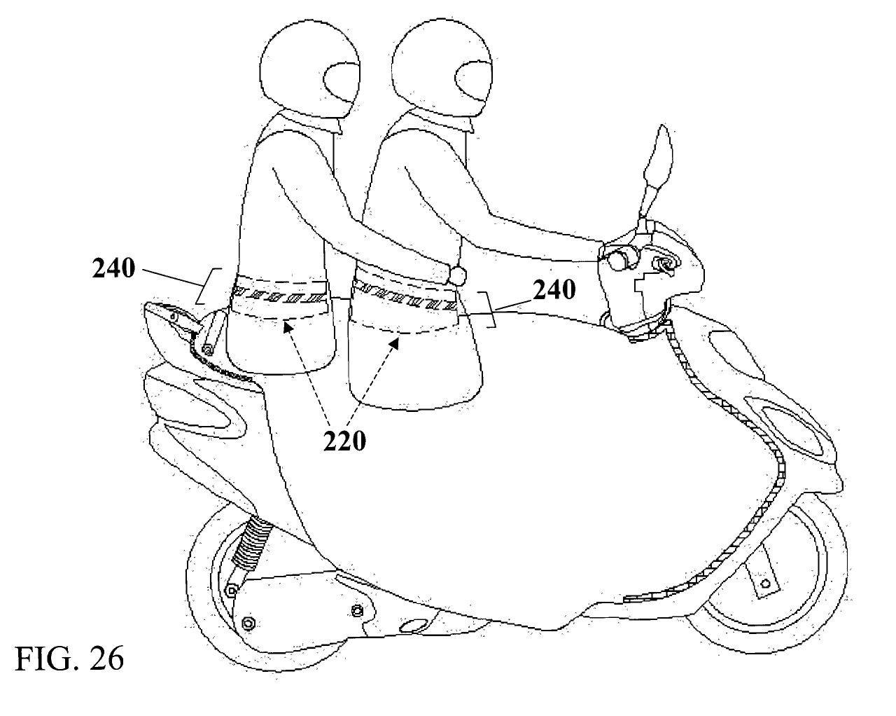

In an alternate embodiment depicted in FIG. 26, fabric gaskets 240 extend upwardly from the openings 220 in the intermediate top panel portion 112 of the conformal weather shield 100. The exteriors of foul weather jackets or coats worn by the driver and passenger are passed over the fabric gasket 240, thereby providing a substantially weatherproof seal for the driver and passenger.

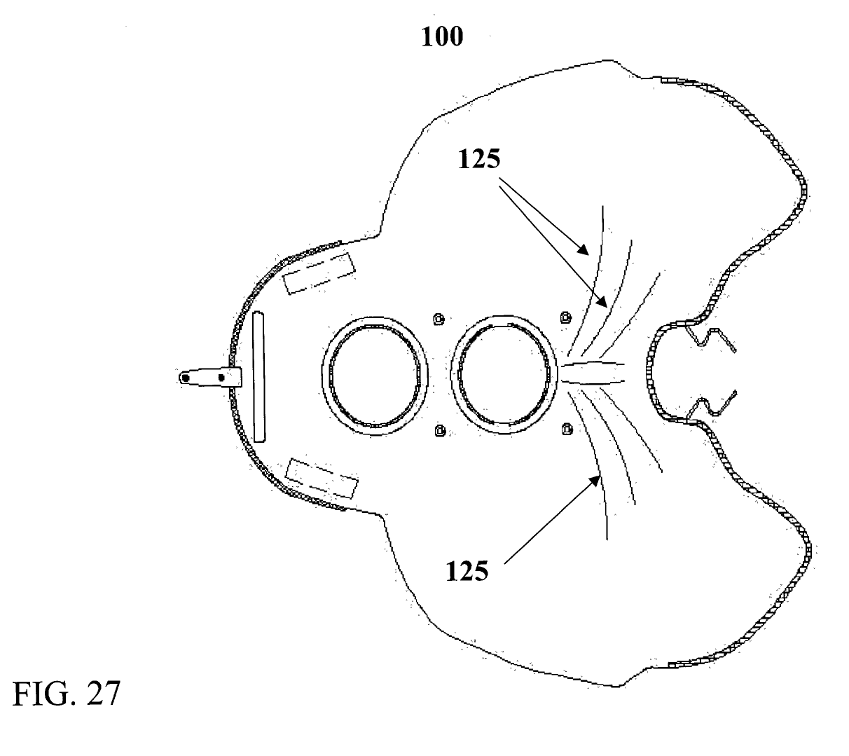

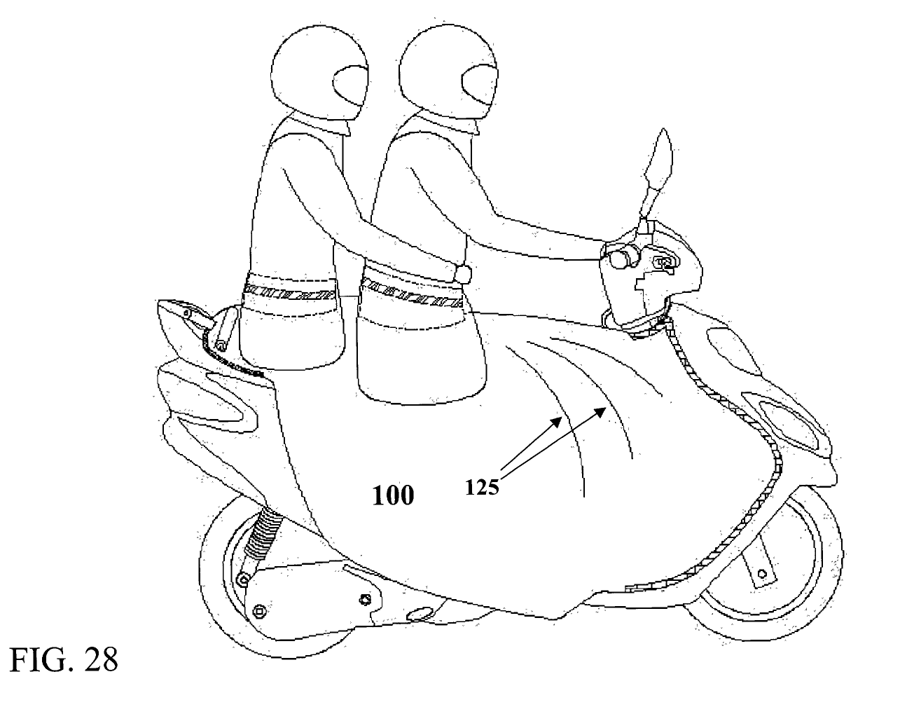

In yet another alternate embodiment of the first preferred embodiment depicted in FIGS. 27 and 28, channels are integrally formed in the top panel portion 110 and side panel portions 120 of the conformal weather shield. The channels 125 serve to direct water away from the driver when the scooter is operated in inclement weather. When the scooter is stored outside during inclement weather the channels 125 also prevent water from puddling on the conformal weather shield 100.

Consideration of the foregoing description of the first preferred embodiment of the present invention illustrates the advantages of the present invention over conventional scooter weather shields. In particular, the overall size and shape of the conformal weather shield 100 closely conforms to the contours of the driver/passenger/scooter combination as shown in FIGS. 5-7. Since the conformal weather shield is intended to operate in combination with purpose-built high-performance foul weather gear worn by the driver and passenger, the driver and passenger will not be encumbered about their upper torso by a bulky and cumbersome poncho-like cover typical of conventional scooter weather shields. This is particularly advantageous for the driver, who can operate the scooter wearing a jacket that is far less cumbersome and restricting then the poncho-like upper torso covers of conventional scooter weather shields.

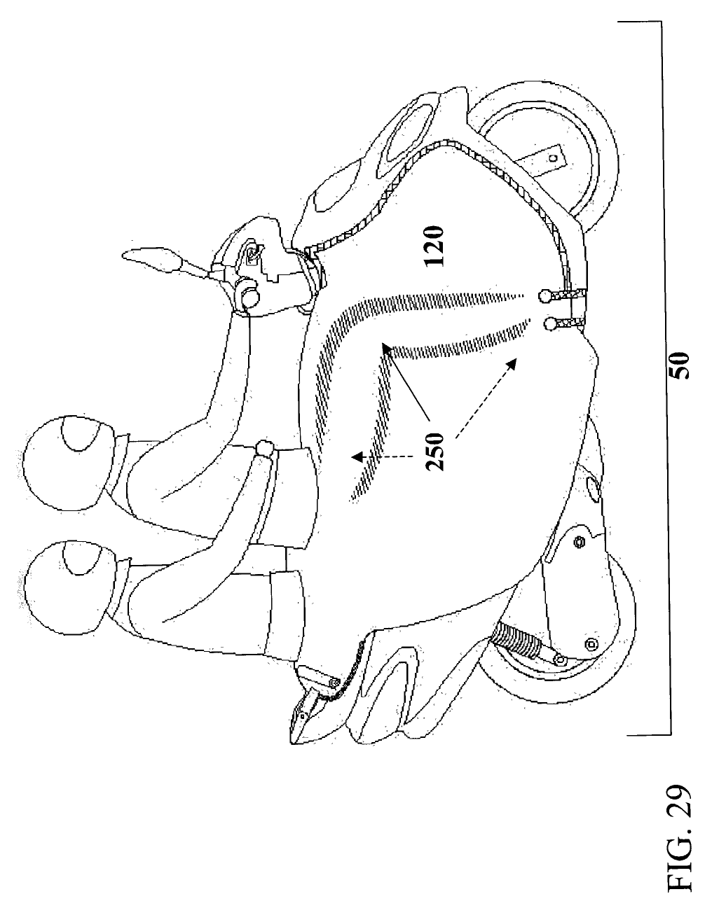

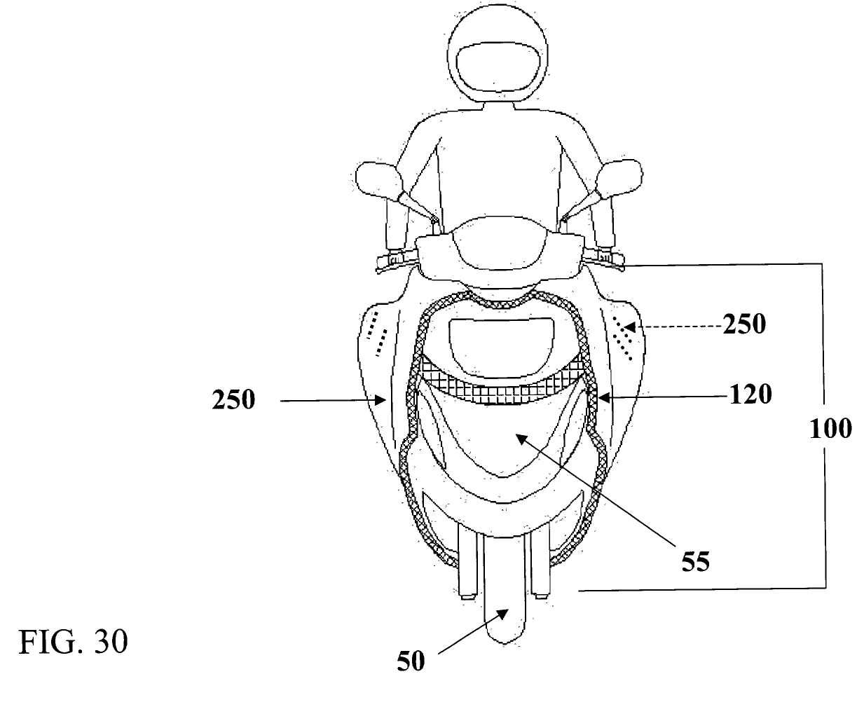

In a further alternate embodiment of the first preferred embodiment of the present invention depicted in FIG. 29, conformal leg bulges 250 are formed in the side panel portions of conformal weather shield 100. The conformal leg bulges 250 are smoothly faired into the overall shape of the conformal weather shield 100, as depicted in the front view depicted in FIG. 30, thereby maintaining the sleek and aerodynamic nature of the conformal weather shield 100. At the same time the conformal leg bulges 250 improve the overall functionality of the conformal weather shield by providing free movement of the driver's and passenger's legs underneath the conformal weather shield 100. The conformal leg bulges 250 permit a degree of up-and-down and side-to-side movement for the driver's and passenger's legs, allowing them to “stretch” during particularly long journeys and thereby contributing to their overall comfort and well-being.

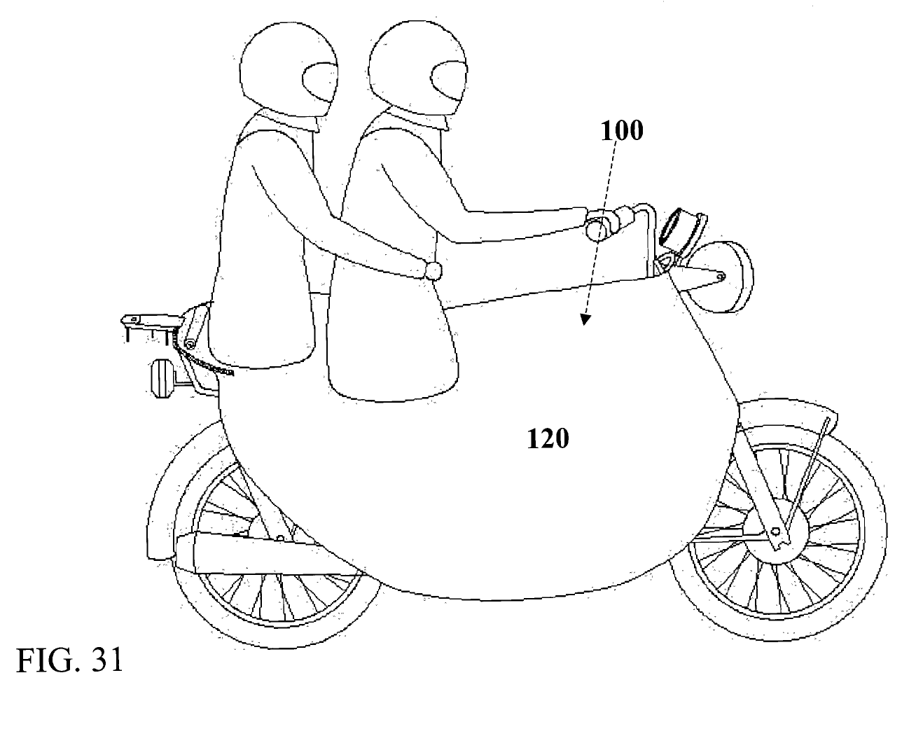

Further it will be understood that the conformal weather shield of the present invention can be used with other vehicles besides scooters. For example, the conformal weather shield of the present invention can be used with motorcycles as depicted in FIG. 31. The conformal weather shield 100 of the present invention can also be used with powered three- and four-wheel vehicles, as well as bicycles.

II. Second Preferred Embodiment

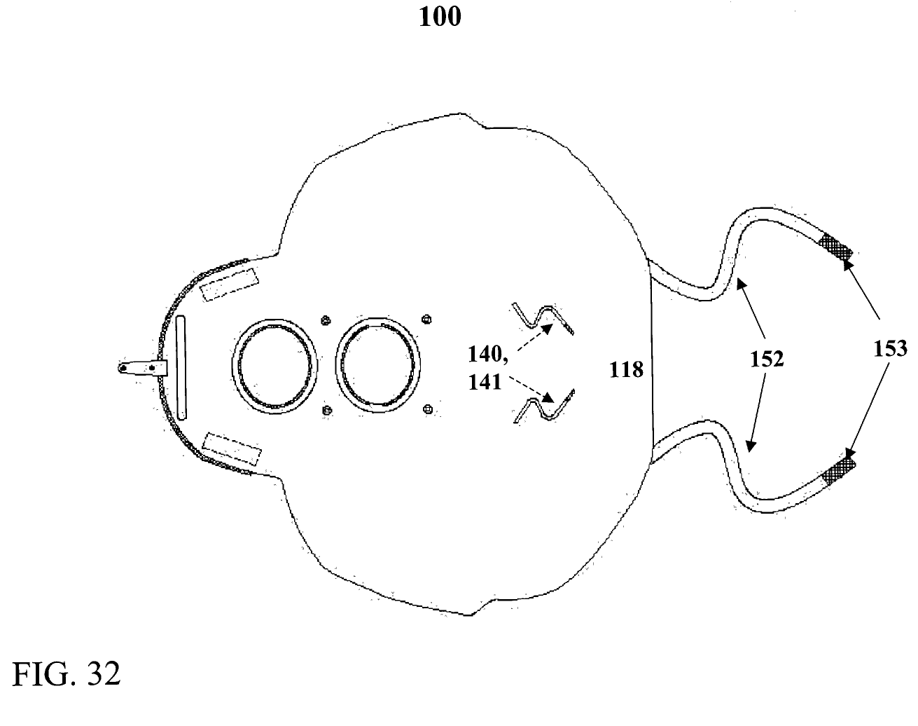

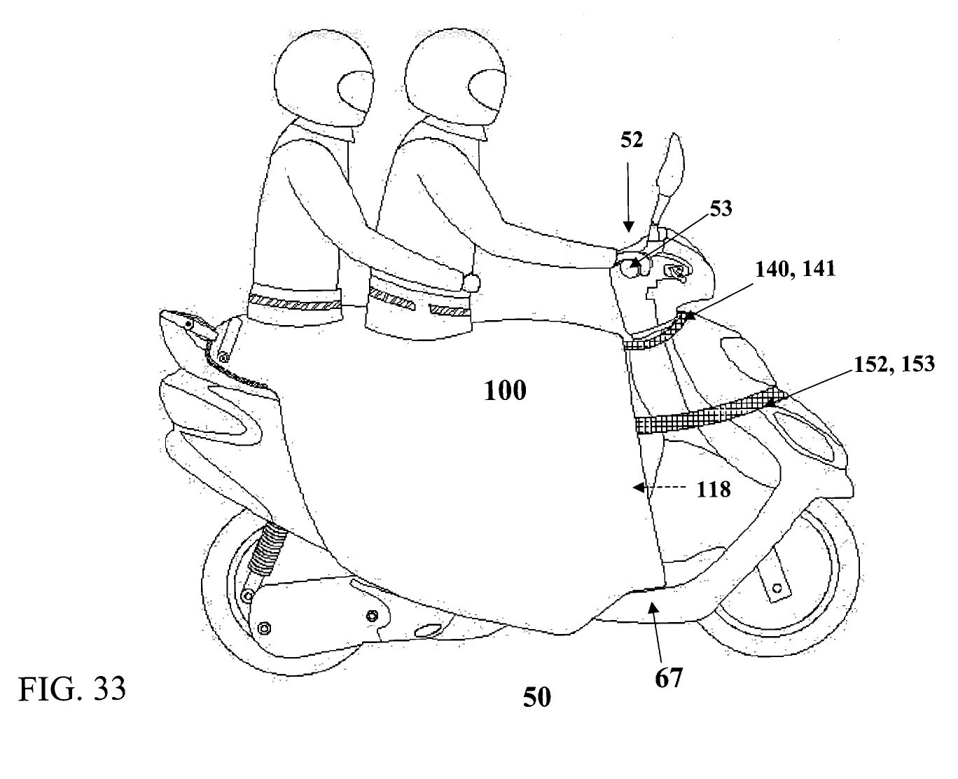

A second preferred embodiment of the present invention is depicted in FIG. 32. In contrast to the first preferred embodiment with separate side panel portions 120, the conformal weather shield of the second preferred embodiment has a top panel portion 110 and side panel portions 120 that converge to form an integral vertically-extending front panel 118 that provides an extra measure of protection for the front of the driver's legs as shown in FIG. 33. The front panel 118 runs vertically from about the vicinity of the instrument panel 52 and handlebars 53 of the scooter 50 to the footboard 67 of the scooter.

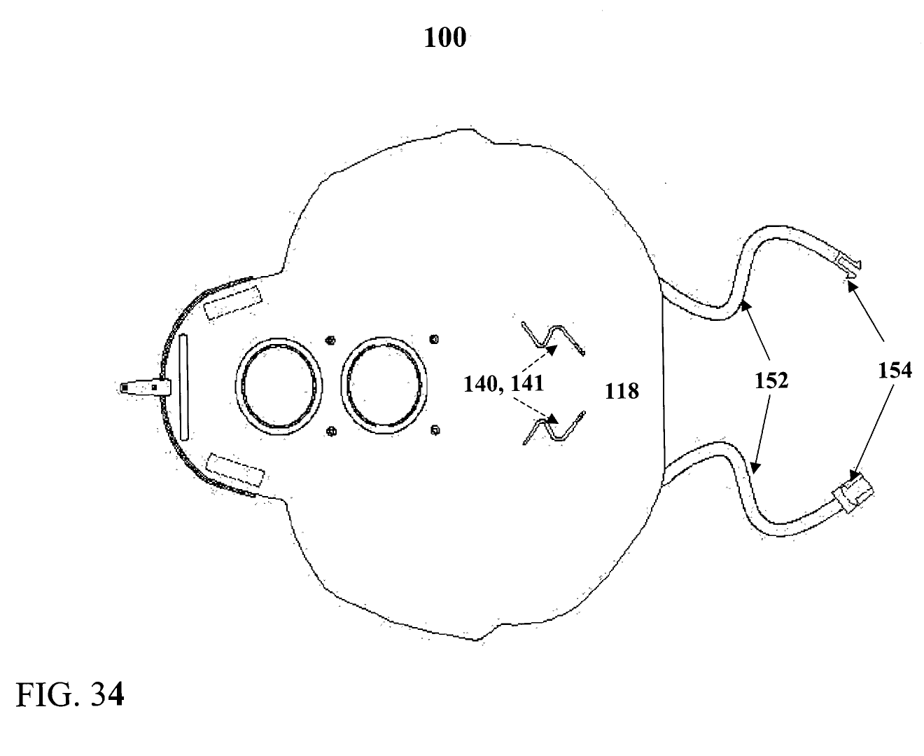

As depicted in FIG. 32, the conformal weather shield 100 of the second preferred embodiment employs four attachment means as in the case of the first preferred embodiment. The first attachment means 140 comprises a drawstring 141 for attaching the front top portion of the conformal weather shield 111 to the steering column 51 of the scooter. The second attachment means 150 comprises a pair of fabric straps 152 extending outward from where the front edges 122 of the side panel portions 120 meet the side edges 119 of the front panel 118. The fabric straps 152 wrap around the front fairing structure 55 and are secured by interlocking, VELCRO-like fabric patches 153. In an alternate embodiment depicted in FIG. 34, the fabric panels are secured by snap closures 154.

III. Third Preferred Embodiment

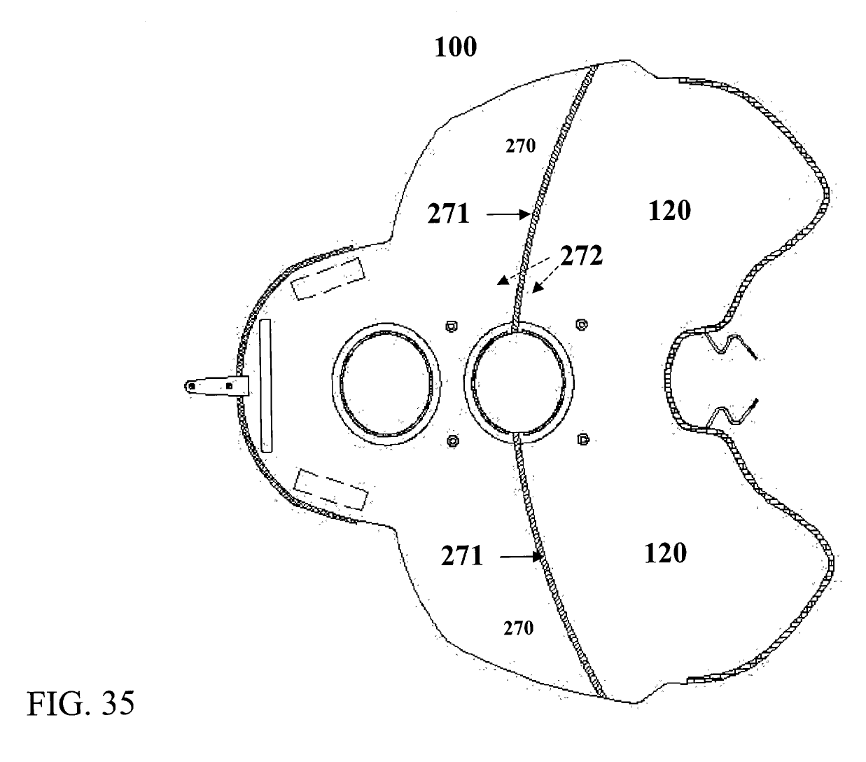

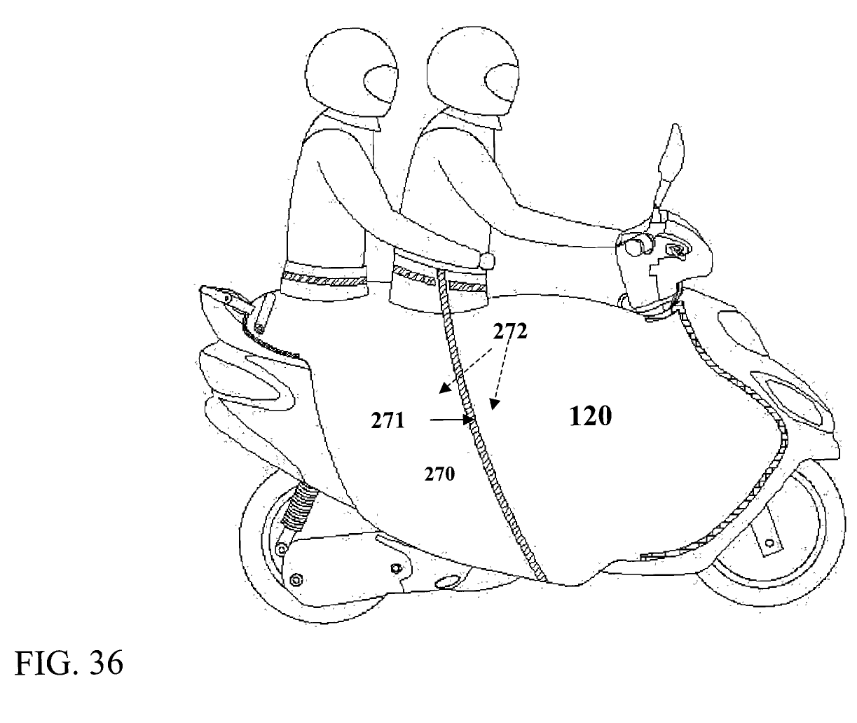

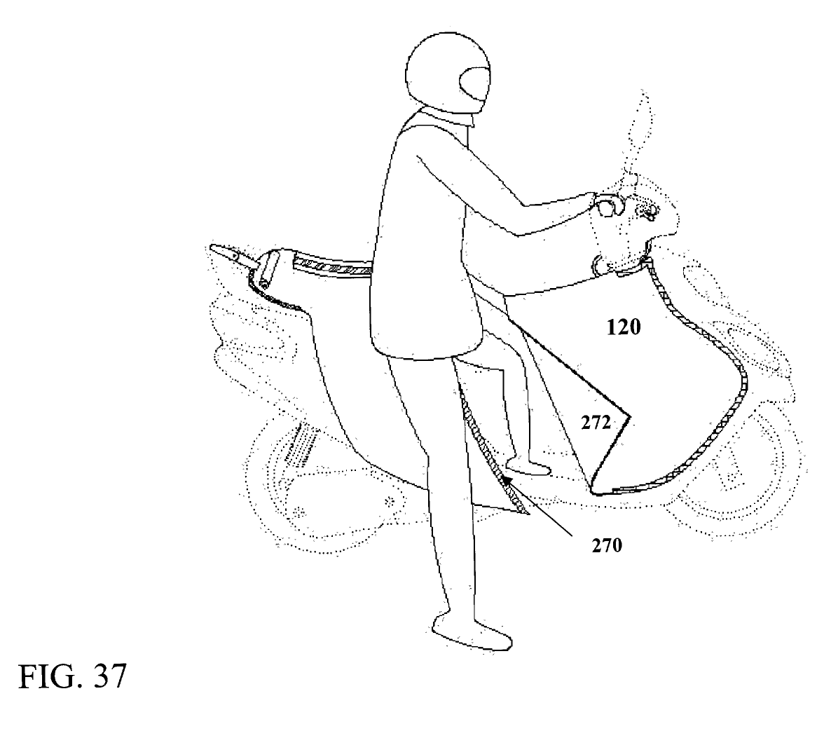

The third preferred embodiment of the present invention comprises a conformal weather shield otherwise made in accordance with the first and second preferred embodiments and further comprising a side access flap 270 for significantly easing access to and mounting of the scooter by the driver in preparation for excursions. The side access flap 270 depicted in FIGS. 35 and 36 comprises an open seam 271 formed by two downwardly-extending edges 272 formed in at least one of the side panel portions 120. The driver enters and exits the seating area of the scooter as shown in FIG. 37 by opening the side access flap 270. The side access flap of the second preferred embodiment is sealed by interlocking, VELCRO-like fabric patches that are stitched to surfaces facing one another on downwardly-extending edges 272. In alternate embodiments, zippers or snap enclosures are used to seal the side access flap 270. In further embodiments an additional seam (not shown) may be formed in the intermediate top panel portion running between the driver opening and passenger opening so that in combination with the side access flap, a passenger may mount the scooter and wrap the conformal weather shield around his or her body without the need of passing the opening over his or her head. The seam running between the driver opening and the passenger opening would likewise be sealable by interlocking, VELCRO-like fabric patches.

The third preferred embodiment of the present invention further increases the ease of use of the conformal weather shield by reducing the need for multiple attachment/detachment operations during lengthy periods of inclement weather. Rather, the driver need merely open the side access flap to mount or exit the scooter 50, otherwise leaving the conformal weather shield in place and thereby minimally interrupting the protection provided to the seating area of the scooter by the conformal weather shield 100.

IV. Fourth Preferred Embodiment

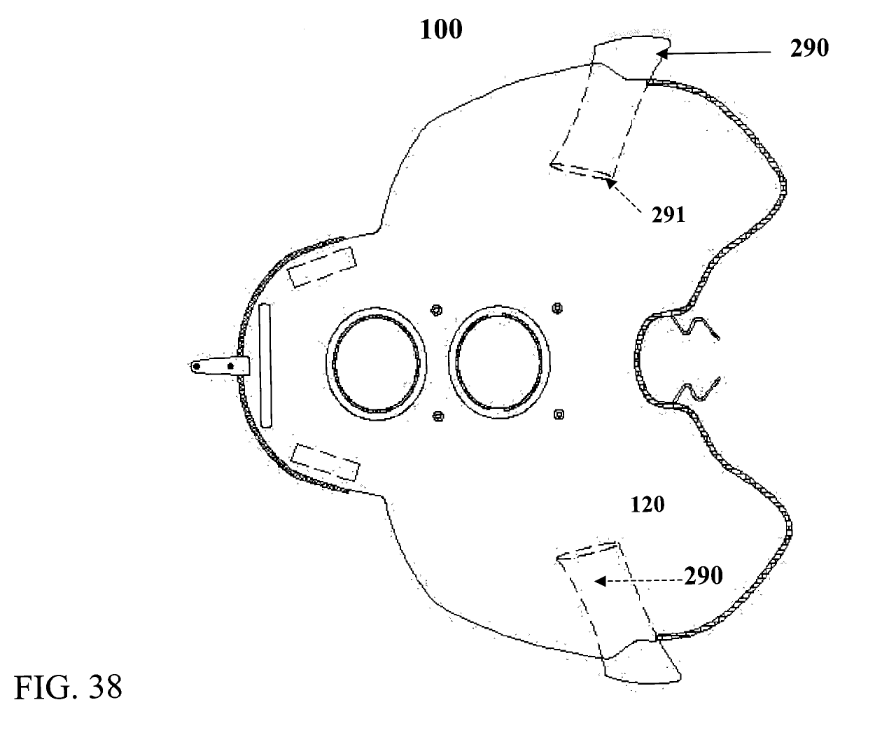

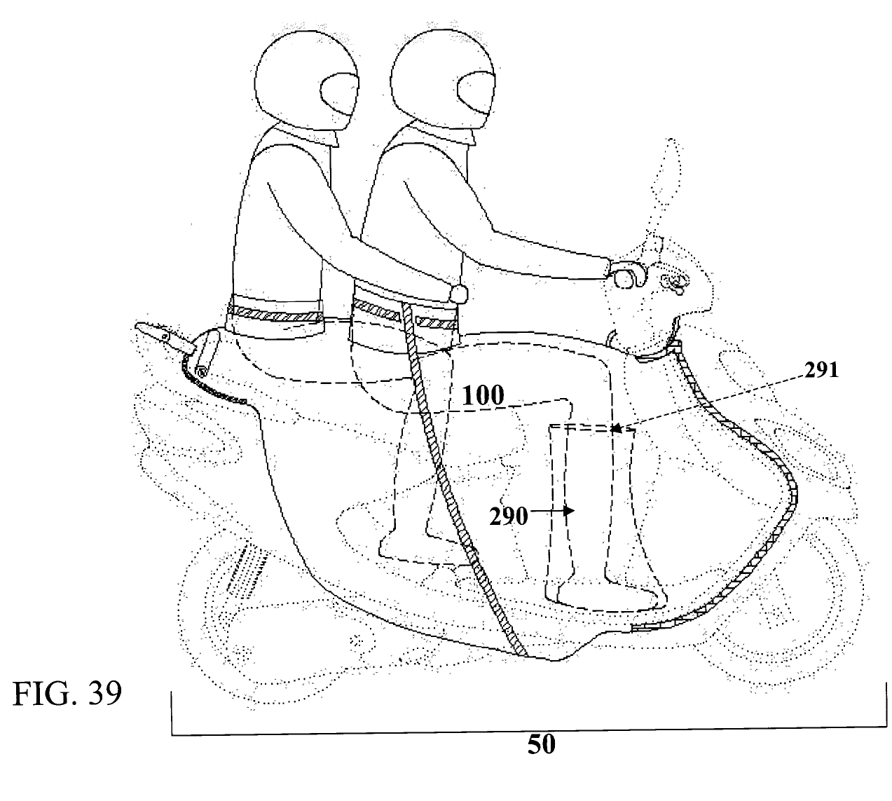

A fourth preferred embodiment of the present invention comprises a conformal weather shield otherwise made in accordance with the preceding embodiments and further comprising a foot covering as depicted in FIGS. 38-41. Mounted on the inside of each side panel portion 120 are two foot coverings 290 as depicted in FIGS. 38-39. In the fourth preferred embodiment depicted in FIG. 38, the foot coverings 290 comprise a loose-fitting boot-like fabric covering that is open at the top end 291 and otherwise enclosed. The fabric foot coverings 290 are made from a durable, weatherproof material. In alternate embodiments the foot coverings 290 are made from other materials well-known to the weatherproof shoe art, for example rubber or neoprene. The upper portions of the fabric foot coverings 290 are loosely attached to the inner side of the side panel portions using interlocking fabric patches 292 or snaps. The loose attachment permits the driver to move his feet relatively freely underneath the conformal weather shield.

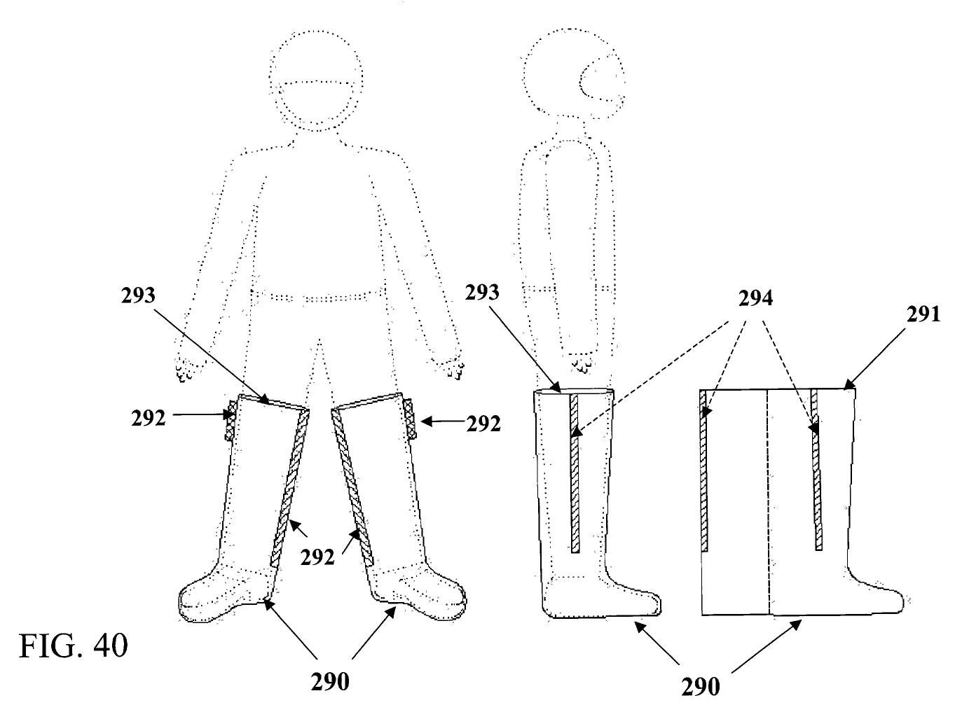

In a first alternate embodiment of the fourth preferred embodiment, the fabric foot coverings 290 further comprise a tightening means 293 for tightening the top portion 294 of the fabric foot covering around the leg of the driver in the vicinity of the calf as depicted in FIG. 40. In alternate embodiments, the tightening means 293 may comprise a drawstring or interlocking, VELCRO-like fabric patches. The tightening means maintains the fabric covering in place much like a garter. This permits the driver to use them separate and apart from the conformal weather shield, for example, to reach shelter in particularly inclement condition.

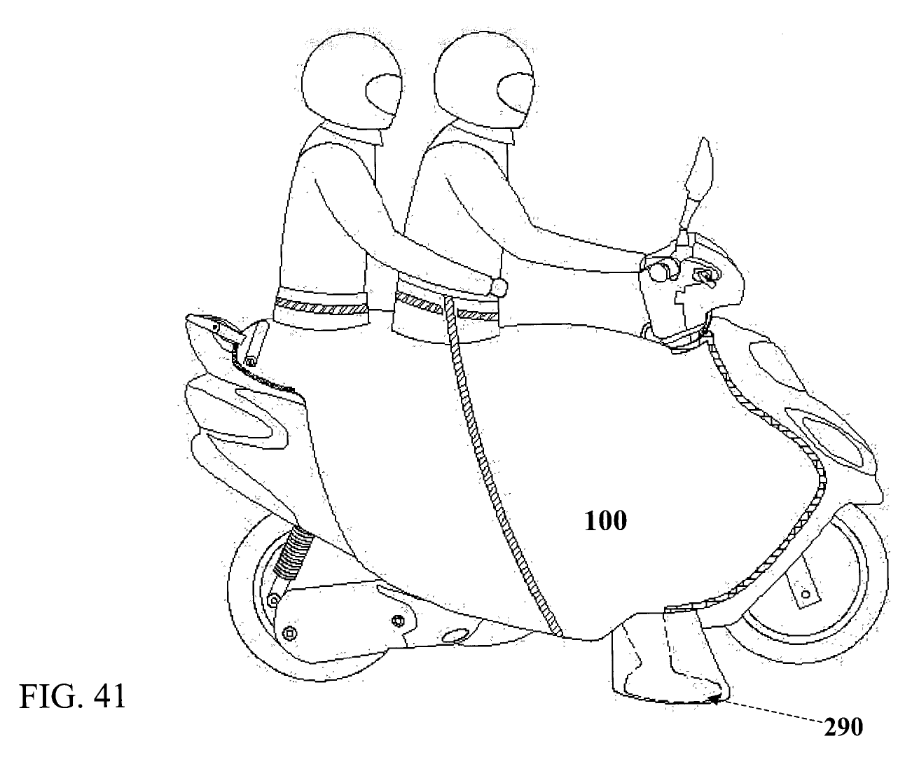

In a second alternate embodiment of the fourth preferred embodiment depicted in FIG. 41, the lower bottom portion of the side panel portions are elastically retained close to the foot board of the scooter or motorcycle, but with sufficient give to permit the driver to extend his foot-covering-covered feet outside the conformal weather shield 100, for example, to brake the bike by contacting the ground with his feet, or to steady the scooter or motorcycle. When doing so, the feet of the driver are protected from rain or other moisture by the foot coverings 290.

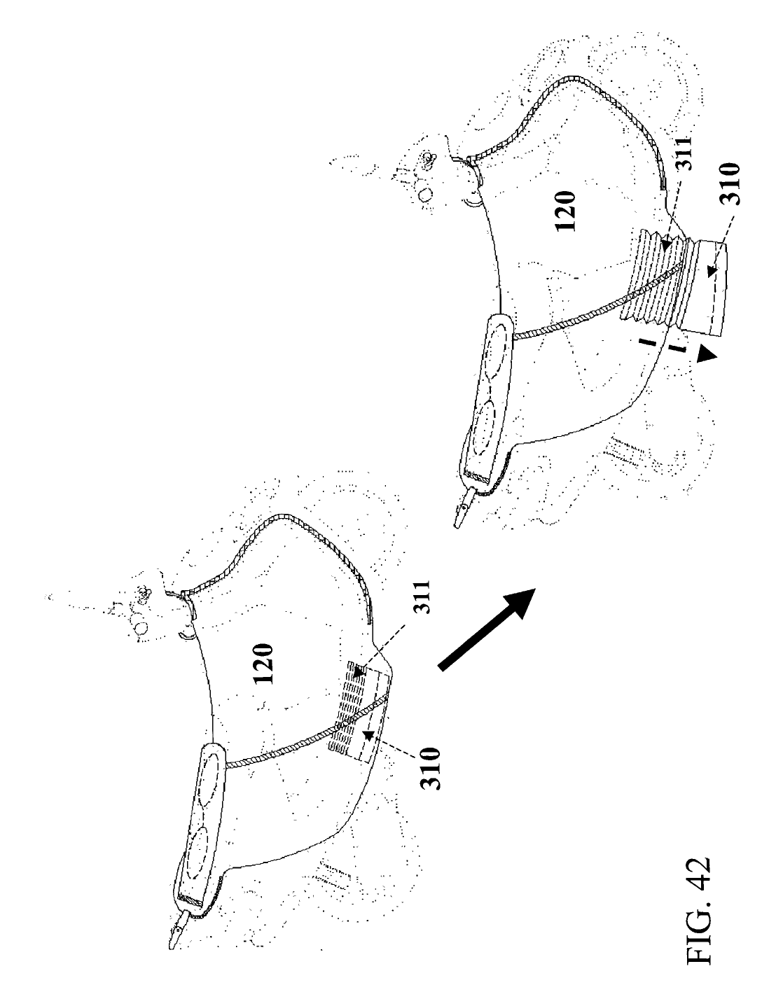

FIG. 42 depicts an alternate foot covering structure 310 otherwise made in accordance with the fourth preferred embodiment of the present invention. In this particular embodiment, the foot covering structure 310 comprises a roughly cylindrically-shaped tube open at the top to permit foot access, closed at the bottom to protect the feet of a driver, and loosely attached to the inside of the side panel portion 120 to permit relatively free movement of the driver's feet when covered by foot covering structure 310. The foot covering structure further comprises an accordion-like expandable structure 311 that permits the foot covering structure 310 to expand and contract with the movement of the driver's feet. Although an accordion-like structure 311 is shown in FIG. 42, in alternate embodiments the expandable structure is constructed from a separate panel made of stretchable materials that rebounds to a smaller dimension when not under tension.

The foot coverings of the fourth preferred embodiment serve to improve the weather protection provided by the conformal weather shield by providing an extra measure of protection to an extremity of the driver that is both particularly close to an edge of the conformal weather shield and which may get wet even with very small seepage past the substantially weatherproof seems of the conformal weather shield, and which may nonetheless need to be extended beyond the protection of the conformal weather shield during normal operations of the scooter. For example, the driver may need to extend his feet beyond the conformal weather shield to provide a braking force with his feet, or to steady the scooter with his feet when the scooter is stationary. In either case, the foot coverings of the third preferred embodiment serve to provide an extra level of weather protection for the driver's feet and footwear.

V. Fifth Preferred Embodiment

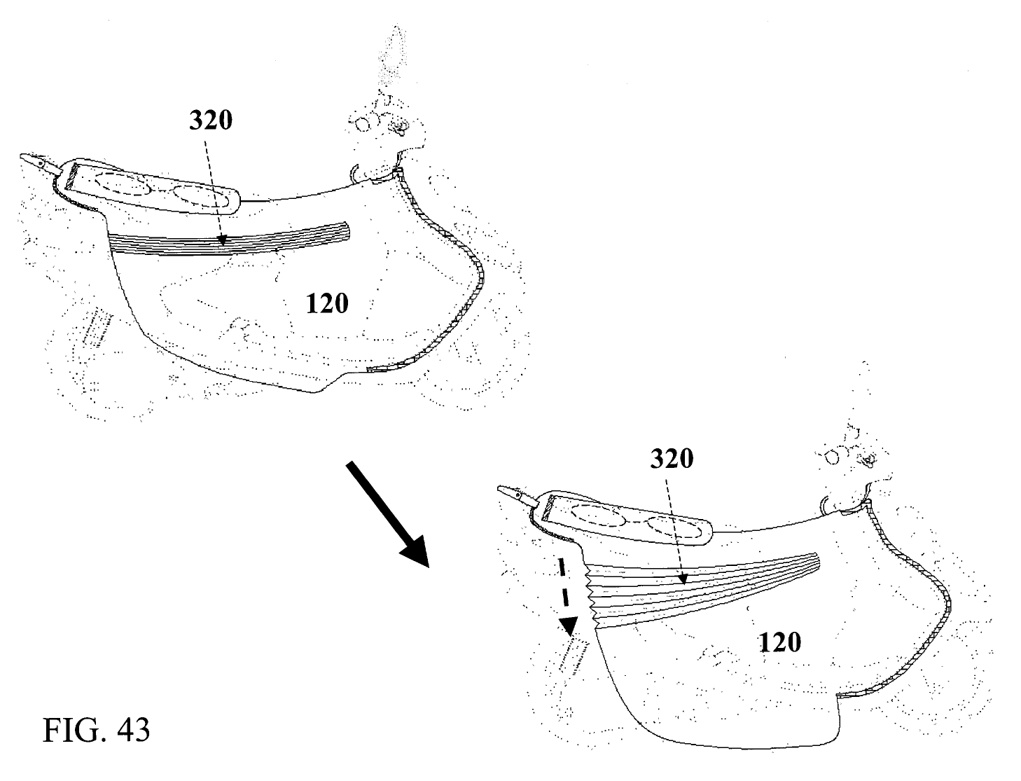

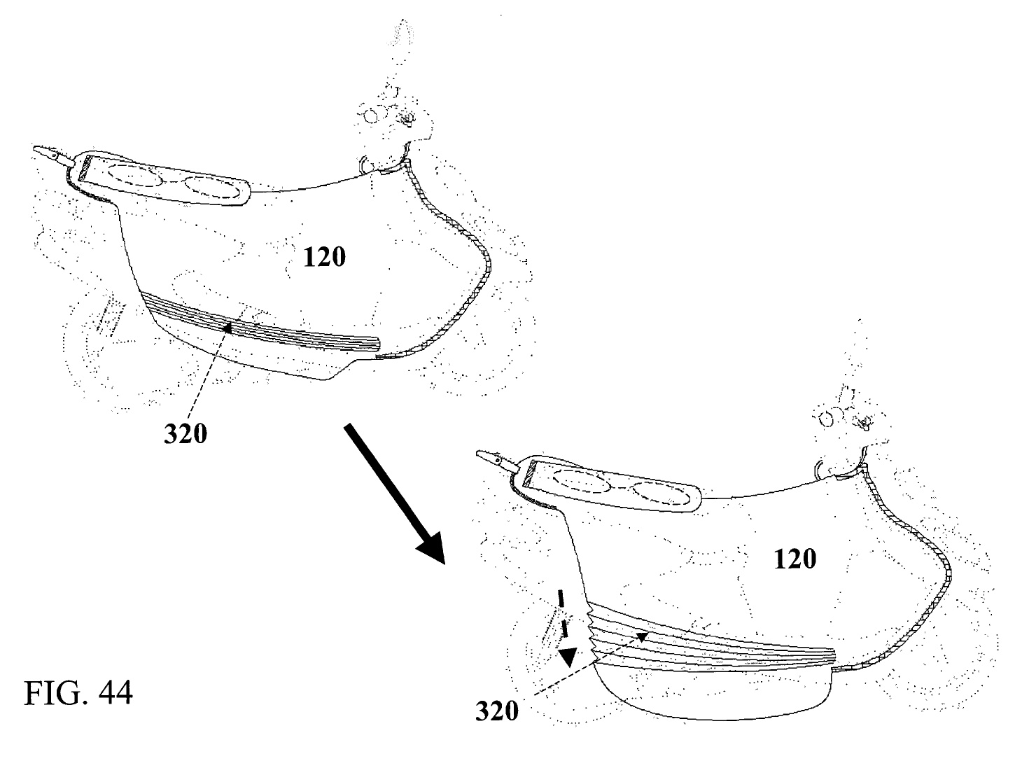

A fifth preferred embodiment of the present invention depicted in FIGS. 43-44 comprises an expandable panel portion 320 incorporated in a side panel portion 120 of a conformal weather shield 100 otherwise made in accordance with the preceding embodiments of the present invention. The expandable panel portion 320 comprises an accordion-like structure 320 that permits the side panel portion 120 of the conformal weather shield 100 to expand and contract with the movements of the driver and passenger. Although an accordion-like structure is depicted in FIGS. 43 and 44, other construction techniques may be used to impart a degree of expandability to the side panel portion 120. For example, the expandable panel portion 320 can be constructed from a weatherproof material that is even more stretchable than the weatherproof material comprising the remaining areas of the side panel portion 120.

As depicted in FIGS. 43 and 44, the expandable panel portion 320 can be located in differing areas of the side panel portion 120 to accomplish differing objectives. For example, in the embodiment depicted in FIG. 43, the expandable side panel 320 would provide for some give in the thigh region of the driver and passenger, while providing for additional protection when the side panel portion 120 is expanded. The give in the thigh region would improve the overall comfort experienced by the driver and passenger when using the conformal weather shield 100.

The expandable panel portion of the fifth preferred embodiment serve to improve the weather protection provided by the conformal weather shield by providing an extra measure of protection to an extremity of the driver that is both particularly close to an edge of the conformal weather shield and which may get wet even with very small seepage past the substantially weatherproof seems of the conformal weather shield. For example, the driver does not need to extend his feet beyond the conformal weather shield to provide a braking force with his feet, or to steady the scooter with his feet when the scooter is stationary. In either case, expandable side panel 320 of the fifth preferred embodiment serve to provide an extra level of weather protection for the driver's feet and footwear.

VI. Sixth Preferred Embodiment

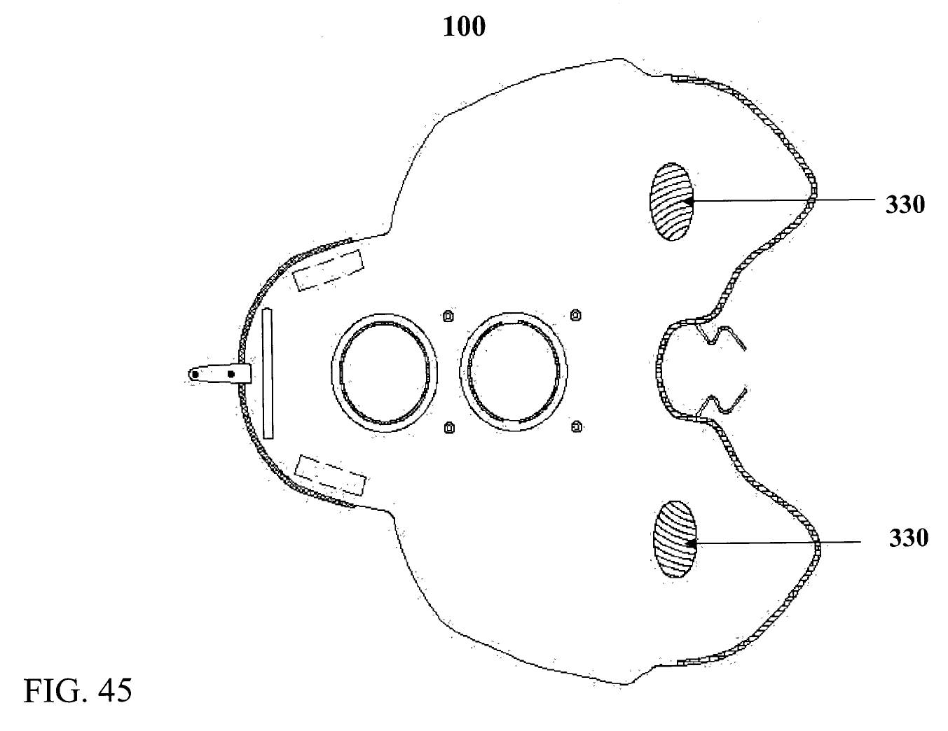

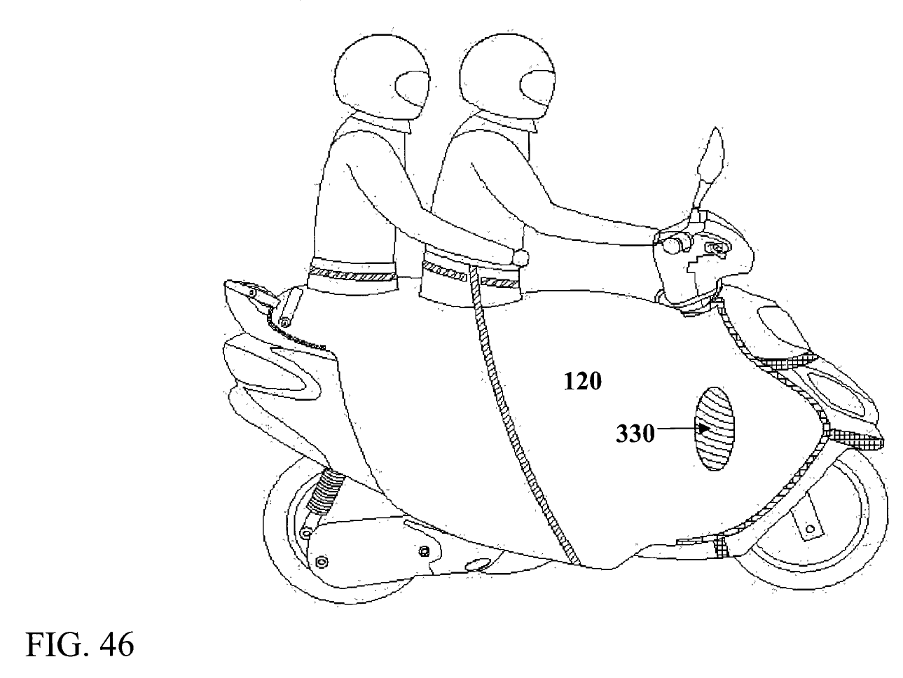

A sixth preferred embodiment of the present invention comprises a conformal weather shield otherwise made in accordance with the preceding embodiments and further comprising a ventilation opening 330 formed in the side panel portions 120 of the conformal weather shield 100 as depicted in FIGS. 45-46. The ventilation opening 330 permits air from outside the conformal weather shield 100 to pass underneath the conformal weather shield 100 and into the region enclosed by the conformal weather shield. The ventilation opening 330 also permits moisture to pass out from underneath the conformal weather shield, but prevents moisture from outside from passing into the region enclosed by the conformal weather shield. The ventilation opening 330 improves the comfort of the driver and passenger be providing for a degree of air circulation underneath the conformal weather shield 100.

VII. Seventh Preferred Embodiment

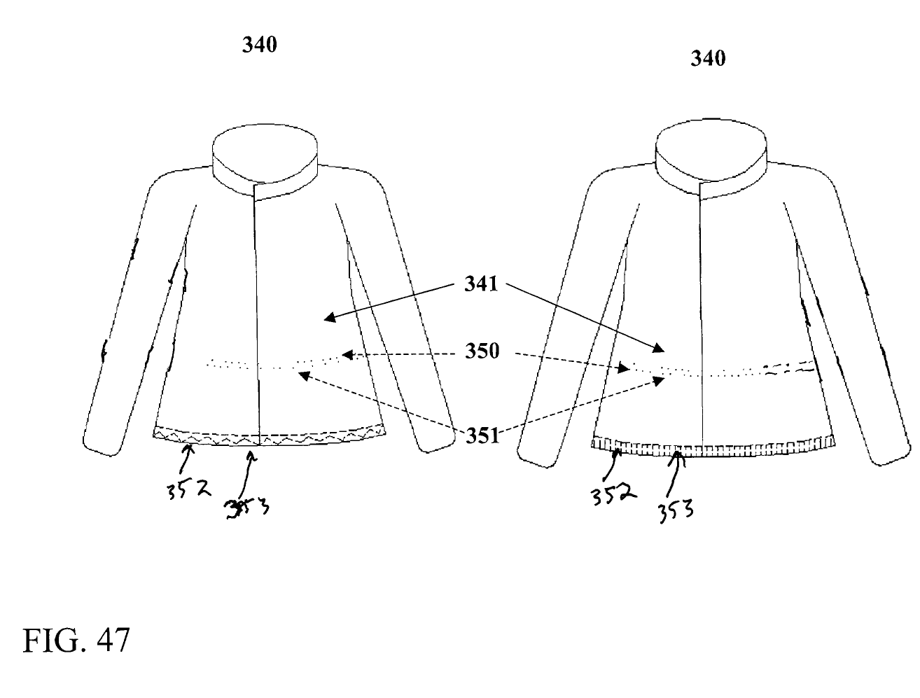

A seventh preferred embodiment of the present invention comprises foul weather jackets or coats 340 for use in combination with the conformal weather shield 100 having fabric gaskets 240 extending upwardly from the driver and/or passenger openings in the top panel portion as depicted in FIGS. 47-49. A foul weather jacket or coat 340 of the seventh preferred embodiment is otherwise made in accordance with conventional practice, but further comprises a downwardly opening waterproof fabric gasket 350 for operating in conjunction with the fabric gasket 240 extending upwardly from the driver or passenger opening 220 of the conformal weather shield 100. The fabric gasket extends 350 circularly around the torso of the foul weather jacket at about the stomach level. The top edge 351 of the fabric gasket 350 is either made integrally with the outer shell 341 of the foul weather jacket 340, or is sewn to the jacket using weatherproof techniques. The fabric gasket 350 extends downwardly an intermediate distance of about a few inches parallel to the outer shell 341 of the jacket or coat. The fabric gasket 350 and outer shell of the jacket or coat 341 form a downwardly facing opening for accepting the upwardly extending fabric gasket 240 of the conformal weather shield 100. The cooperation of the fabric gasket 350 of the foul weather jacket or coat 340 and the fabric gasket 240 of the conformal weather shield 100 further improves the weatherproof nature of the conformal weather shield.

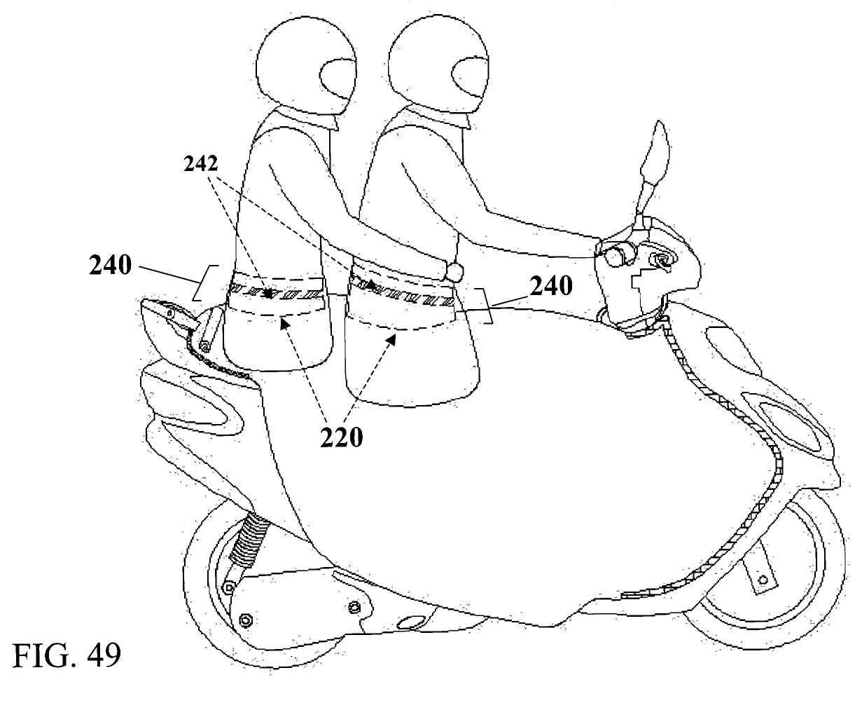

In alternate embodiments of the fifth preferred embodiment, oppositely facing interlocking VELCRO-like fabric patches 242, 352 may be stitched on the outer surface 241 of the fabric gasket 240 extending upwardly from the conformal weather shield 100, and on the inner surface 353 of the fabric gasket of the foul weather jacket or coat. In combination the interlocking fabric patches further serve to provide a substantially weatherproof seal between the conformal weather shield and the foul weather jacket or coat as depicted in FIG. 49. In other alternate embodiments, other means may be used to connect the upwardly extending gasket 240 to the fabric gasket 350 of the foul weather jacket 340, for example, zippers or snaps.

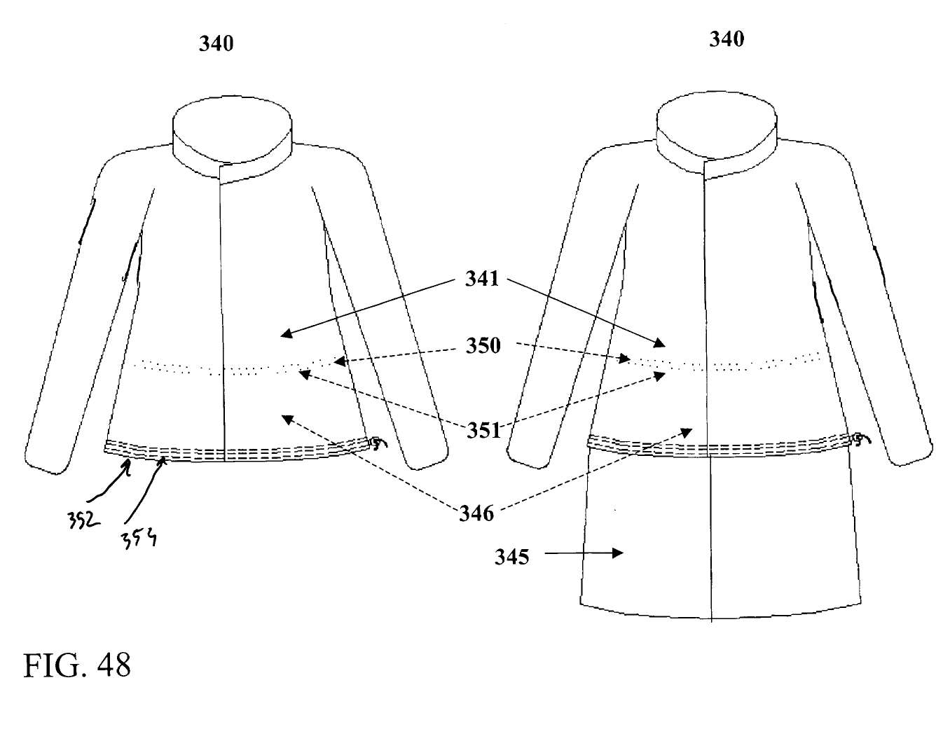

In a still another alternate embodiment of the seventh preferred embodiment depicted in FIG. 48, the foul weather jacket or coat further comprises an expandable panel 345 that may be stowed when not in use. The expandable panel 345 of this particular alternate embodiment can be rolled up and stored in a lower portion of the jacket 346 thereby reducing the length of the foul weather jacket 340 when it is attached to the conformal weather shield 100. This provides for a greater degree of comfort for the driver and passenger because the expandable panel 345 is not needed to protect the lower torso and upper leg areas when the conformal weather shield 100 is performing this function. When the driver and passenger depart from the scooter during periods of inclement weather, the expandable panel 345 may be extended to provide for an increased degree of protection of their lower torsos and upper leg areas.

VIII. Eighth Preferred Embodiment

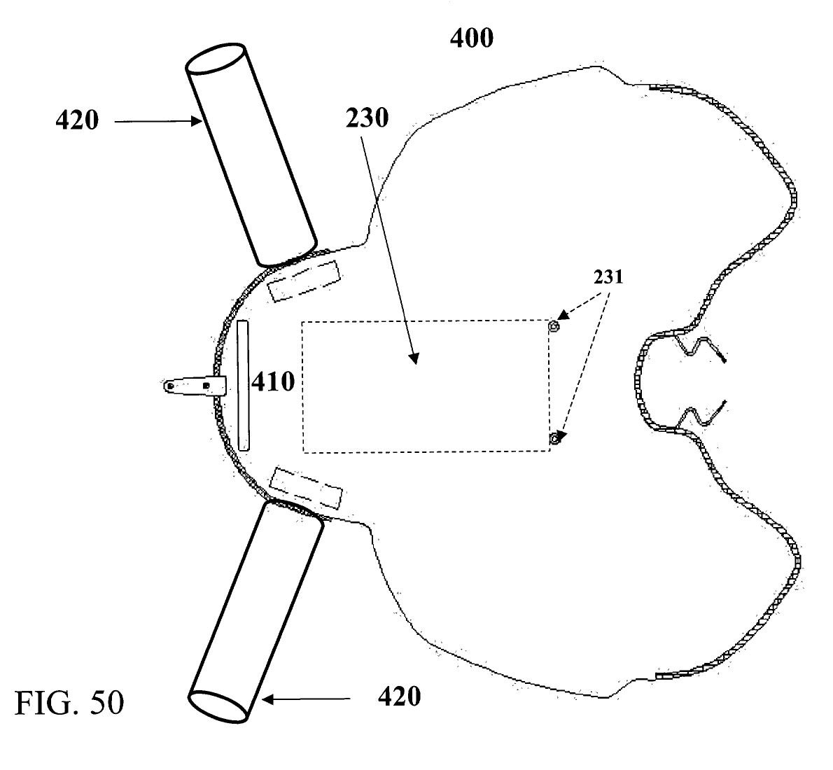

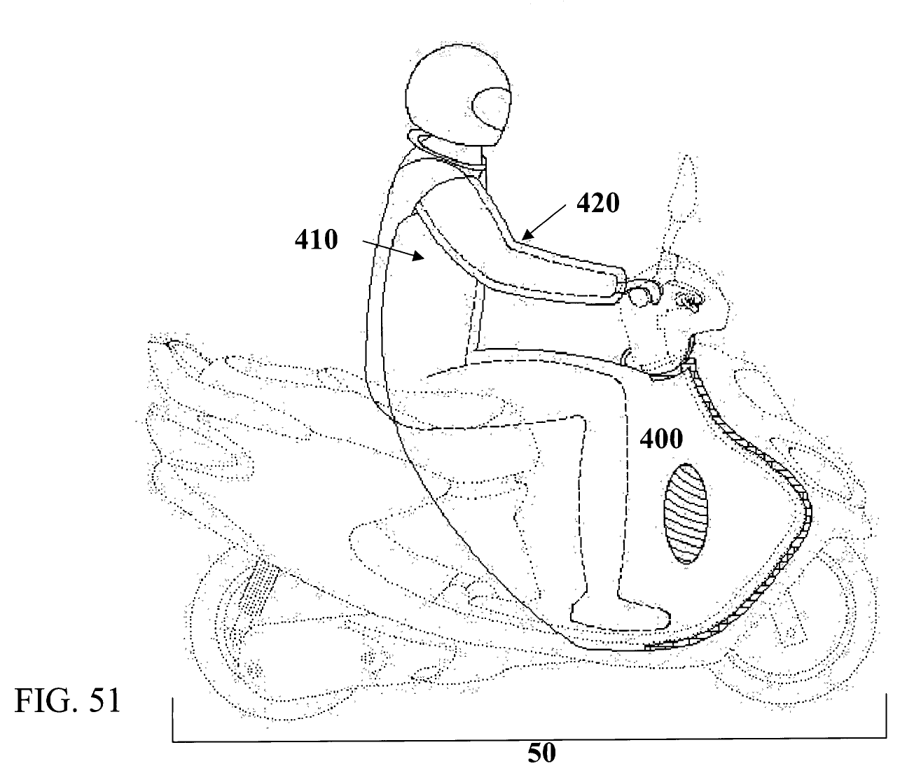

An eighth preferred embodiment of the present invention comprises a conformal weather shield 400 otherwise made in accordance with the preceding embodiments and which further comprises an apron-like extension 410 for use on windy or sunny days as depicted in FIGS. 50-51. The apron-like conformal weather shield 400 drapes around the upper torso and arms of a driver or passenger to protect the driver or passenger from the sun or wind. In alternate embodiments of the seventh preferred embodiment, the apron-like conformal weather shield may or may not provide protection for the back of a driver or passenger. In other alternate embodiments, detachable sleeves 420 are attached to the conformal weather shield 400.

Thus it is seen that a conformal weather shield and associated protective garments are provided by the present invention for protecting drivers and passengers of scooters and motorcycles during periods of inclement weather. One skilled in the art will appreciate that the various embodiments described herein can be practiced individually; in combination with one or more other embodiments described herein; or in combination with weather shields having differing designs from those described herein. For example, the side access flap of the third preferred embodiment can be used in combination with weather shields that are not conformal or streamlined in construction to improve the ease of use of such weather shields. The remaining features of the preferred and alternate embodiments described herein can be combined with other weather shields, either individually or in combination with one another, in the same manner as the side access flap of the third preferred embodiment. Further, one skilled in the art will appreciate that the present invention can be practiced by other than the described embodiments; that these described embodiments are presented for the purposes of illustration and not of limitation; and that the present invention is therefore limited only by the claims which follow.

1. A conformal weather shield for attachment to a scooter or motorcycle to cover the lower torso and extremities of a driver and at least a portion of the scooter or motorcycle during periods of inclement weather, the conformal weather shield comprising:
a top panel portion made of flexible, durable and substantially weatherproof material, the top panel portion having a front top panel portion, an intermediate top panel portion, and a rear top panel portion, wherein when mounted on the scooter or motorcycle the top panel portion covers the lower torso and thighs of the driver and the seating area of the scooter or motorcycle;
side panel portions extending downward from the top panel portion on each side of the scooter or motorcycle, wherein each side panel portion further comprise a top edge connecting the side panel portion to the top panel portion; a front edge; a bottom edge; and a rear edge, wherein the side panel portions cover the driver's legs and at least a portion of either side of the scooter or motorcycle;
a driver opening formed in the top panel portion for permitting the upper torso of the driver to extend through the top panel portion, wherein the driver opening further comprises a tightening means for tightening the driver opening about the lower torso of the driver to form a substantially weather proof seal; and
attachment means for connecting the conformal weather shield to the scooter.

2. The conformal weather shield of claim 1 wherein the conformal weather shield additionally accommodates a passenger and further comprises:
a passenger opening formed in the top panel portion for permitting the upper torso of the passenger to extend through the top panel portion, wherein the passenger opening further comprises a tightening means for tightening the passenger opening about the lower torso of the passenger to form a substantially weather proof seal

3. The conformal weather shield of claim 1, wherein the conformal weather shield is intended to work in combination with a foul weather jacket worn by the driver, the conformal weather shield further comprising:
a fabric gasket extending upwardly from the driving opening, wherein the fabric gasket works in cooperation with the foul weather jacket worn by the driver to provide a substantially weatherproof seal

4. The conformal weather shield of claim 2, wherein the conformal weather shield is intended to work in combination with foul weather jackets worn by the driver and passenger, the conformal weather shield further comprising:
fabric gaskets extending upwardly from the driving and passenger openings, wherein the fabric gaskets work in cooperation with the foul weather jackets worn by the driver and passenger to provide a substantially weatherproof seal for protecting the lower torsos of the driver and passenger against the weather.

5. The conformal weather shield of claim 3, wherein the fabric gasket further comprises:
tightening means for tightening the fabric gasket about the lower torso of the driver.

6. The conformal weather shield of claim 4, wherein the fabric gaskets further comprise:
tightening means for tightening the fabric gaskets about the lower torsos of the driver and passenger.

7. The conformal weather shield of claim 1 further comprising:
a side access opening formed in at least one of the side panel portions, wherein the side access opening comprises a substantially vertical seam formed in the side access panel starting at the edge of the driver opening and extending downward toward the vicinity of the bottom edge of the at least one side panel portion, wherein the side access opening permits the driver to mount the scooter and motorcycle without detaching the attachment means, and wherein the conformal weather shield can be draped about the lower torso and legs of the driver by closing the side access opening after the driver has mounted the scooter or motorcycle; and
closing means for temporarily closing the vertical seam comprising the side access opening after the driver has mounted or departed from the scooter or motorcycle.

8. The conformal weather shield of claim 7, wherein the closing means comprises interlocking, VELCRO-like, fabric patches attached to the two edges of the at least one side panel portion comprising the side access opening.

9. The conformal weather shield of claim 7, wherein the closing means comprises a zipper.

10. The conformal weather shield of claim 7, wherein the closing means comprises a plurality of snaps.

11. The conformal weather shield of claim 1, wherein the side panel portions further comprise:
leg bulges smoothly faired into the side panel portions of the conformal weather shield, the leg bulges permitting the driver to move his legs up and down and side to side within the conformal weather shield while maintaining the overall conformal configuration of the conformal weather shield.

12. The conformal weather shield of claim 1 further comprising;
foot enclosures attached to inside surfaces of the side panel portions, wherein the foot enclosures comprise boot-like enclosures of sufficient size to permit the driver to easily slip his footwear-covered feet into the foot enclosures; and
foot enclosure attachment means for loosely attaching the foot enclosures to the inside surfaces of the side panel portions, wherein the foot enclosure attachment means permits a degree of movement independent of the side panel portions, thereby allowing the driver to continue using his feet to control the scooter or motorcycle.

13. The conformal weather shield of claim 12 wherein the foot enclosure attachment means comprises interlocking, VELCRO-like fabric patches.

14. The conformal weather shield of claim 12 wherein the foot enclosure attachment means comprises snaps.

15. The conformal weather shield of claim 12 wherein the foot enclosure attachment means permits the driver to detach the foot enclosure from the inside surface of side panel portions in order so that the foot enclosures may be used independently of the conformal weather shield during periods of inclement weather in a galosh-like manner; and
foot enclosure tightening means for tightening the foot enclosure about the leg of the driver when the foot enclosure is used in a galosh-like manner.

16. The conformal weather shield of claim 1 further comprising:
foot enclosures attached to inside surfaces of the side panel portions, wherein the foot enclosures comprise roughly cylindrical structures, open at the top and closed at the bottom, wherein the foot enclosures are of sufficient size to permit the driver to easily slip his footwear-covered feet into the foot enclosures, and wherein the foot enclosures are made of substantially weatherproof material and provide an additional measure of protection against moisture;
and foot enclosure attachment means for loosely attaching the foot enclosures to the inside surfaces of the side panel portions, wherein the foot enclosure attachment means permits a degree of movement independent of the side panel portions, thereby allowing the driver to continue using his feet to control the scooter or motorcycle.

17. The conformal weather shield of claim 1 further comprising ventilation slots that permit outside air to circulate underneath the conformal weather shield while substantially preventing moisture from entering the region covered by the conformal weather shield.

18. The conformal weather shield of claim 1 wherein the side panel portions of the conformal weather shield further comprise:
expandable panel portions, wherein the expandable panel portions are capable of expanding to a greater degree than the rest of the side panel portions, and wherein the expandable panel portions provide additional freedom of movement for the driver, allowing the driving to move his lower extremities and legs underneath the conformal weather shield.

19. The conformal weather shield of claim 1 wherein the side panel portions of the conformal weather shield further comprise:
expandable panel portions, wherein the expandable panel portions are capable of expanding to a greater degree than the rest of the side panel portions, and wherein the expandable panel portions are located in the vicinity of the bottom edge of the side panel portions and can expand to provide an extra measure of protection for the footwear of the driver.

20. The conformal weather shield of claim 18 wherein the expandable panel portions comprise an accordion-like structure.

21. The conformal weather shield of claim 18 wherein the expandable panel portions are made from an elastic-like material capable of expanding when under tension and contracting when released.

22. The conformal weather shield of claim 19 wherein the expandable panel portions comprise an accordion-like structure.

23. The conformal weather shield of claim 19 wherein the expandable panel portions are made from an elastic-like material capable of expanding when under tension and contracting when released.

24. The conformal weather shield of claim 1 wherein the attachment means further comprises:
a first attachment means for connecting the front top panel portion to a steering column of the scooter or motorcycle in the vicinity of the instrument panel and handlebars.

25. The conformal weather shield of claim 24 wherein the first attachment means further comprises a drawstring.

26. The conformal weather shield of claim 24 wherein the first attachment means further comprises:
two fabric straps attached to opposite edges of the front top panel portion, and wherein the two fabric straps are of sufficient length to wrap around the steering column and overlap each other; and
interlocking, VELCRO-like fabric patches attached to each end of the fabric straps for connecting the fabric straps together to hold the front top panel portion of the conformal weather shield in place.

27. The conformal weather shield of claim 24 wherein the first attachment means further comprises:
two fabric straps attached to opposite edges of the front top panel portion, and wherein the two fabric straps are of sufficient length to wrap around the steering column and overlap each other; and
interlocking snaps attached to each end of the fabric straps for connecting the fabric straps together to hold the front top panel portion of the conformal weather shield in place.

28. The conformal weather shield of claim 1 wherein the attachment means further comprises:
a second attachment means for connecting the front edges of the side panel portions of the conformal weather shield to a front fairing structure of a scooter or motorcycle.

30. The conformal weather shield of claim 28 wherein the second attachment means further comprises:
at least two pairs of cooperating fabric straps, wherein each member of a pair are attached to each front edge of each side panel portion at about the same vertical position, and wherein each fabric strap is of sufficient length to permit the strap to wrap around the front fairing structure of the scooter or motorcycle and overlap the other member of the pair;
interlocking, VELCRO-like fabric patches attached to each end of the fabric straps for connecting the fabric straps together to hold the front edges of the side panel portions of the conformal weather shield in place.

31. The conformal weather shield of claim 28 wherein the second attachment means further comprises:
at least two pairs of cooperating fabric straps, wherein each member of a pair are attached to each front edge of each side panel portion at about the same vertical position, and wherein each fabric strap is of sufficient length to permit the strap to wrap around the front fairing structure of the scooter or motorcycle and overlap the other member of the pair;
interlocking.snaps attached to each end of the fabric straps for connecting the fabric straps together to hold the front edges of the side panel portions of the conformal weather shield in place.

32. The conformal weather shield of claim 28 wherein the second attachment means comprises
a strip of interlocking, VELCRO-like material mounted to each side of the front fairing structure of the scooter or motorcycle; and
a strip of interlocking, VELCRO-like material attached to each front edge of the side panel portions for cooperating with the strips mounted on the front fairing structure of the scooter or motorcycle to hold the front edges of the side panel portions in place.

33. The conformal weather shield of claim 28 wherein the second attachment means further comprises:
screw plates for mounting the front edges of the side panel portions of the conformal weather shield to the side edges of the front fairing structure of the scooter or motorcycle.

34. The conformal weather shield of claim 33 wherein the second attachment means further comprises:
a fabric boot for storing the conformal weather shield when not in use, the fabric boot also attached to the front fairing structure of the scooter or motorcycle by the screw plates.

35. The conformal weather shield of claim 28 wherein the second attachment means further comprises:
elastic material stitched to the front edge of each side panel portion; and
cleat-like structures attached to the side edges of the front fairing structure of the scooter or motorcycle for cooperating with the elastic material stitched to the front edges of the side panel portions of the conformal weather shield to hold the conformal weather shield in place when the conformal weather shield is subject to a rearward tension.

36. The conformal weather shield of claim 1 wherein the attachment means further comprises:
a third attachment means for connecting the bottom edges of the side panel portions to one another.

37. The conformal weather shield of claim 36 wherein the third attachment means further comprises:
at least one hole formed in the bottom edge of each side panel portion; and
a drawstring for looping through the holes in the side panel portions to connect the side panel portions together when tag ends of the drawstring are tied together in order to hold the bottom edges of the side panel portions of the conformal weather shield in place.

38. The conformal weather shield of claim 36 wherein the third attachment means further comprises:
at least a pair of fabric straps wherein one member of the pair are mounted to each bottom edge of each side panel portion, wherein the fabric straps are of sufficient length to overlap when passed underneath the scooter or motorcycle; and
interlocking, VELCRO-like fabric patches attached to each end of the fabric straps, wherein when connected the interlocking, VELCRO-like fabric patches connect the ends of the fabric straps together and thereby hold the bottom edges of the side panel portions of the conformal weather shield in place.

39. The conformal weather shield of claim 36 wherein the third attachment means further comprises:
at least a pair of fabric straps wherein one member of the pair are mounted to each bottom edge of each side panel portion, wherein the fabric straps are of sufficient length to overlap when passed underneath the scooter or motorcycle; and
interlocking snaps attached to each end of the fabric straps, wherein when connected the interlocking snaps connect the ends of the fabric straps together and thereby hold the bottom edges of the side panel portions of the conformal weather shield in place.

40. The conformal weather shield of claim 1 wherein the attachment means further comprises:
a fourth attachment means for connecting the rear top panel portion of the conformal weather shield to the rear of the scooter or motorcycle in the vicinity of the rear portion of the seat structure.

41. The conformal weather shield of claim 40 wherein the fourth attachment means further comprises:
a fabric strap attached to the rear top panel portion of the conformal weather shield, wherein the fabric strap has a snap enclosure, the fabric snap for connecting the rear top panel portion to a loop-like passenger handle structure of the scooter or motorcycle.

42. The conformal weather shield of claim 40 wherein the fourth attachment means further comprises:
a screw plate for connecting the rear top panel portion of the conformal weather shield to the scooter or motorcycle in the vicinity of the rear portion of the seat structure.

43. The conformal weather shield of claim 42 wherein the fourth attachment means further comprises a fabric boot for storing the conformal weather shield when not in use, the fabric boot also attached to the scooter or motorcycle by the screw plate.

44. The conformal weather shield of claim 3 further comprising:
a foul weather jacket for use in combination with the conformal weather shield, wherein the foul weather jacket is separate from the conformal weather shield, the foul weather jacket comprising an outer shell of substantially weatherproof material and a fabric gasket attached to the outer shell at about the lower torso level of the foul weather jacket, the foul weather jacket outer shell and fabric gasket forming a downwardly facing opening for accepting the upwardly extending fabric gasket of the conformal weather shield, wherein the gaskets of the conformal weather shield and foul weather jacket forming a substantially weatherproof seal.

45. The conformal weather shield of claim 44 wherein the fabric gaskets of the conformal weather shield and foul weather jacket have attachment means for connecting the foul weather jacket and conformal weather shield together.

46. The conformal weather shield of claim 45 wherein the attachment means comprises interlocking, VELCRO-like fabric patches attached to both an outside edge of the fabric gasket of the conformal weather shield and an inside edge of the gasket of the foul weather jacket.

47. The conformal weather shield of claim 4 further comprising:
foul weather jackets for use in combination with the conformal weather shield, wherein the foul weather jacket is separate from the conformal weather shield, the foul weather jacket comprising an outer shell of substantially weatherproof material and a fabric gasket attached to outer shell at about the lower torso level of the foul weather jacket, the foul weather jacket outer shell and fabric gasket forming a downwardly facing opening for accepting the upwardly extending fabric gaskets of the conformal weather shield, wherein the gaskets of the conformal weather shield and foul weather jackets forming a substantially weatherproof seal.

48. The conformal weather shield of claim 44 wherein the fabric gaskets of the conformal weather shield and foul weather jackets have attachment means for connecting the foul weather jackets and conformal weather shield together.

49. The conformal weather shield of claim 45 wherein the attachment means comprises interlocking, VELCRO-like fabric patches attached to both an outside edge of the fabric gasket of the conformal weather shield and inside edges of the gasket of the foul weather jackets.

50. The conformal weather shield of claim 1 further comprising:
water conducting channels formed in the top panel portions and side panel portions for conducting water away from the conformal weather shield and scooter or motorcycle to which it is attached.

51. The conformal weather shield of claim 1 wherein the front top panel portion wraps vertically downward, and the front edges of the side panel portions wrap toward one another and converge with the downwardly-extending portion of the front top panel portion to form a front vertical panel covering the knees, shins ankles and feet of the driver.
